(19) United States
(12) Patent Application Publication
(10) Pub. No.: US 2024/0193322 A1
(43) Pub. Date: Jun. 13, 2024

(54) CARRIER TRANSPORT SIMULATION METHOD, APPARATUS, MEDIUM, AND ELECTRONIC DEVICE

(71) Applicant: Origin Quantum Computing Technology (Hefei) Co., Ltd, Hefei (CN)

(72) Inventor: Yongjie ZHAO, Hefei (CN)

(73) Assignee: Origin Quantum Computing Technology (Hefei) Co., Ltd, Hefei (CN)

(21) Appl. No.: 18/421,748

(22) Filed: Jan. 24, 2024

Related U.S. Application Data
(63) Continuation of application No. PCT/CN2022/108827, filed on Jul. 29, 2022.

(30) Foreign Application Priority Data
Jul. 30, 2021 (CN) 202110868294.X
Jul. 30, 2021 (CN) 202110868312.4
Jul. 30, 2021 (CN) 202110868460.6
Jul. 30, 2021 (CN) 202110876439.0

(51) Int. Cl. G06F 30/20

(52) U.S. Cl. CPC G06F 30/20

(57) ABSTRACT

Disclosed are a carrier transport simulation method, a carrier transport simulation apparatus, a medium, and an electronic device. A physical simulation model, and an initial condition and/or a boundary condition for carrier transport in a semiconductor device are determined; a mathematical physical equation correspondingly for solving the physical simulation model is determined; and a carrier density in the semiconductor device is determined based on the initial condition and/or the boundary condition, and the mathematical physical equation, to implement a simulation of carrier transport in the semiconductor device, so as to implement a simulation of carrier transport in a semiconductor device.

### CROSS-REFERENCE TO RELATED APPLICATIONS

This application is a continuation of International Application No. PCT/ CN2022/108827, filed on Jul. 29, 2022, which claims priority to Chinese Patent Application No. CN202110876439.0, filed on Jul. 30, 2021 and entitled “CARRIER TRANSPORT SIMULATION METHOD, APPARATUS, MEDIUM, AND ELECTRONIC DEVICE”; Chinese Patent Application No. CN202110868312.4, filed on Jul. 30, 2021 and entitled “CARRIER TRANSPORT SIMULATION METHOD, APPARATUS, MEDIUM, AND ELECTRONIC DEVICE”; Chinese Patent Application No. CN202110868460.6, filed on Jul. 30, 2021 and entitled “CARRIER TRANSPORT SIMULATION METHOD, APPARATUS, MEDIUM, AND ELECTRONIC DEVICE”; and Chinese Patent Application No. CN202110868294.X, filed on Jul. 30, 2021 and entitled “CARRIER TRANSPORT SIMULATION METHOD, APPARATUS, MEDIUM, AND ELECTRONIC DEVICE”. The disclosures of the aforementioned applications are hereby incorporated by reference in their entireties.

### TECHNICAL FIELD

The present disclosure pertains to the field of quantum simulation computing technologies, and in particular, to a carrier transport simulation method, a carrier transport simulation apparatus, a medium, and an electronic device.

### BACKGROUND

Modern integrated circuits have been widely used as the core of electronic information devices, and their stability has always been a concern in various fields. With continuous reduction of a feature size in a process of a modern integrated circuit, quantum effect has an increasingly significant impact on electrical performance of a semiconductor device included in the integrated circuit. The electrical performance is determined by transport of carriers (electrons and holes are collectively referred to as carriers in physics) in the semiconductor device, and an understanding of the transport of carriers in a semiconductor device determines development of an integrated circuit in the future. Currently, there is no effective method for studying carrier transport in a semiconductor device.

### SUMMARY

An objective of embodiments of the present disclosure is to provide a carrier transport simulation method, a carrier transport simulation apparatus, a medium, and an electronic device.

An embodiment of the present application provides a carrier transport simulation method, and the method includes: determining a physical simulation model, an initial condition, and/or a boundary condition for carrier transport in a semiconductor device; determining a mathematical physical equation correspondingly for solving the physical simulation model; and determining a carrier density in the semiconductor device based on the initial condition and/or the boundary condition, and the mathematical physical equation, to implement a simulation of carrier transport in the semiconductor device.

Optionally, the physical simulation model includes at least one of the following: a model for a semi-classical system, a model for a closed quantum system, and a model for an open quantum system. A mathematical physical equation corresponding to the model for a semi-classical system is a Poisson's equation; a mathematical physical equation corresponding to the model for a closed quantum system is the Poisson's equation and a Schrödinger equation; and a mathematical physical equation corresponding to the model for an open quantum system is the Poisson's equation and a Green's function equation corresponding to the Schrödinger equation.

Optionally, the determining an initial condition and/or a boundary condition for carrier transport in a semiconductor device includes: constructing a geometric model of the semiconductor device; gridding the geometric model based on a finite volume method to obtain a plurality of first control volumes; and determining an initial condition and/or a boundary condition for each of the first control volumes.

Optionally, the physical simulation model is a model for a semi-classical system, and a mathematical physical equation corresponding to the model for a semi-classical system is a Poisson's equation. The determining a carrier density in the semiconductor device based on the initial condition and/or the boundary condition, and the mathematical physical equation, to implement a simulation of carrier transport in the semiconductor device includes: determining a carrier density in the semiconductor device based on the initial condition and/or the boundary condition, and the Poisson's equation, to implement the simulation of carrier transport in the semiconductor device.

Optionally, the Poisson's equation is as follows:

$$∇ \cdot ( - {ε}_{r} ( \vec{r} ) ∇ ) ϕ ( \vec{r} ) = \frac{- q}{{ε}_{0}} ( n ( \vec{r} ) )$$

Where ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density.

Optionally, n(\vec{r}) is as follows:

$$n ( \vec{r} ) = \frac{\sqrt{{m}_{x}^{*} ( \vec{r} ) {m}_{y}^{*} ( \vec{r} ) {m}_{z}^{*} ( \vec{r} )}}{{π}^{3 / 2} {ℏ}^{3}} {( {K}_{B} T )}^{3 / 2} {F}_{1 / 2} ( \frac{μ ( \vec{r} ) - {E}_{c} ( \vec{r} )}{{K}_{B} T / q} )$$

Where m*ₓ(\vec{r}), m*_{y}(\vec{r}), and m*_{z}(\vec{r}) are spatial-related directional effective masses, ℏ is a reduced Planck constant, K_{B} is a Boltzmann constant, T is a temperature in a unit of Kelvin, F_{1/2} is a half-order Fermi-Dirac integral, μ(\vec{r}) is an electrochemical potential, E_{C}(\vec{r}) is an energy at a conduction band edge, E_{c}(\vec{r})=−eϕ(\vec{r})χ₀(\vec{r}), e is an elementary charge, and χ₀(\vec{r}) is a carrier affinity.

Optionally, if the physical simulation model is the model for a semi-classical system, the determining a carrier density in the semiconductor device based on the initial condition and/or the boundary condition, and the mathematical physical equation includes: determining an analytical equation set expressed in a numerical matrix format based on the initial condition and/or the boundary condition for each of the first control volumes and the Poisson's equation; transforming the analytical equation set expressed in a numerical matrix format into an analytical equation set expressed in a form of residuals; solving the analytical equation set expressed in a form of residuals based on a Newton iteration algorithm to obtain a first electrostatic potential; and determining the carrier density in the semiconductor device based on the first electrostatic potential.

Optionally, the determining the carrier density in the semiconductor device based on the first electrostatic potential includes: substituting the first electrostatic potential as the electrostatic potential to be determined into n(\vec{r}) to obtain the carrier density in the semiconductor device.

Optionally, the determining the carrier density in the semiconductor device based on the first electrostatic potential includes: determining, based on the first electrostatic potential, a target region with an electrostatic potential density in the geometric model being greater than or equal to a preset threshold; gridding the target region based on a finite volume method, to obtain a plurality of second control volumes, where the second control volume is smaller than the first control volume; and determining a second electrostatic potential based on the plurality of second control volumes, where spatial distribution accuracy of the second electrostatic potential is higher than spatial distribution accuracy of the first electrostatic potential; and substituting the second electrostatic potential as the electrostatic potential to be determined into n(\vec{r}) to obtain the carrier density in the semiconductor device.

Optionally, the physical simulation model is a model for a closed quantum system, and a mathematical physical equation corresponding to the model for a closed quantum system is a Poisson's equation and a Schrödinger equation. The determining a carrier density in the semiconductor device based on the initial condition and/or the boundary condition, and the mathematical physical equation, to implement a simulation of carrier transport in the semiconductor device includes: determining the carrier density in the semiconductor device based on the initial condition and/or the boundary condition, the Poisson's equation, and the Schrödinger equation, to implement the simulation of carrier transport in the semiconductor device.

Optionally, the Poisson's equation is as follows:

$$∇ \cdot ( - {ε}_{r} ( \vec{r} ) ∇ ) ϕ ( \vec{r} ) = \frac{- q}{{ε}_{0}} ( n ( \vec{r} ) )$$

Where ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density.

Optionally, the Schrödinger equation is as follows:

$$[ - ∇ \cdot \frac{{ℏ}^{2}}{2 {qm}_{x , y , z}^{*} ( \vec{r} )} ∇ + {V}_{eff} ( \vec{r} ) ] {ψ}_{i} ( \vec{r} ) = {e}_{i} {ψ}_{i} ( \vec{r} )$$

Where

$$∇ \cdot \frac{{ℏ}^{2}}{2 {qm}_{x , y , z}^{*} ( \vec{r} )} ∇$$

is a Laplace operator including

$$\frac{{ℏ}^{2}}{2 {qm}_{x , y , z}^{*} ( \vec{r} )} ,$$

ℏ is a reduced Planck constant, m*_{x,y,z}(\vec{r}) is a spatial-related directional effective mass, eᵢ and ψᵢ(\vec{r}) are an eigenvalue and an eigenfunction of a closed quantum system, respectively; V_{eff}(\vec{r}) is a valid potential energy function, V_{eff}(\vec{r})=−ϕ(\vec{r})+χ₀(\vec{r})+V_{xc}(n(\vec{r})), χ₀(\vec{r}) is a carrier affinity, and V_{xc}(n(\vec{r})) is an exchange-correlation function.

Optionally, n(\vec{r}) is as follows:

$$n ( \vec{r} ) = {\sum }_{i} {f}_{F} ( {e}_{i} ) {ψ}_{i} ( \vec{r} ) {ψ}_{i}^{+} ( \vec{r} ) = {\sum }_{i} \frac{1}{1 + exp ( ( {e}_{i} - μ ( \vec{r} ) ) / {V}_{T} )} {ψ}_{i} ( \vec{r} ) {ψ}_{i}^{+} ( \vec{r} )$$

Where ƒ_{F}(eᵢ) is a Fermi function, V_{T} is a carrier thermal voltage, V_{T}=K_{B}T/q, μ(\vec{r}) is an electrochemical potential, K_{B} is a Boltzmann constant, and T is a temperature in a unit of Kelvin.

Optionally, if the physical simulation model is the model for a closed quantum system, the determining a carrier density in the semiconductor device based on the initial condition and/or the boundary condition, and the mathematical physical equation includes: determining a first analytical equation set expressed in a numerical matrix format based on the initial condition and the boundary condition for each of the first control volumes and the Poisson's equation; determining the Schrödinger equation corresponding to each of the first control volumes to obtain a second analytical equation set expressed in a numerical matrix format; determining an initial carrier density; and iteratively solving the second analytical equation set based on the initial carrier density and the first analytical equation set to obtain the carrier density in the semiconductor device.

Optionally, the iteratively solving the second analytical equation set based on the initial carrier density and the first analytical equation set to obtain the carrier density in the semiconductor device includes: solving the first analytical equation set based on the initial carrier density to obtain a first electrostatic potential; determining an estimated carrier density based on the first electrostatic potential; solving the second analytical equation set based on the estimated carrier density to obtain a first eigenfunction; determining a target carrier density based on the first eigenfunction; and if a difference between the target carrier density and the initial carrier density is greater than a preset error, using the target carrier density as a new initial carrier density, and then solving the first analytical equation set based on the new initial carrier density to obtain a first electrostatic potential; if the difference between the target carrier density and the initial carrier density is less than or equal to the preset error, using the target carrier density as the carrier density in the semiconductor device.

Optionally, the physical simulation model is the model for an open quantum system, and a mathematical physical equation corresponding to the model for an open quantum system is the Poisson's equation and a Green's function equation corresponding to the Schrödinger equation. The determining a carrier density in the semiconductor device based on the initial condition and/or the boundary condition, and the mathematical physical equation, to implement a simulation of carrier transport in the semiconductor device includes: determining the carrier density in the semiconductor device based on the initial condition and/or the boundary condition, the Poisson's equation, and the Green's function equation corresponding to the Schrödinger equation, to implement the simulation of carrier transport in the semiconductor device.

Optionally, the Poisson's equation is as follows:

$$∇ \cdot ( - {ε}_{r} ( \vec{r} ) ∇ ) ϕ ( \vec{r} ) = \frac{- q}{{ε}_{0}} ( n ( \vec{r} ) )$$

Where ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density.

Optionally, the Green's function equation corresponding to the Schrödinger equation is as follows:

$$( ( E + i η ) - ( - ∇ \cdot \frac{{ℏ}^{2}}{2 {qm}_{x , y , z}^{*} ( \vec{r} )} ∇ + {V}_{eff} ( \vec{r} ) ) ) G ( \vec{r} , \vec{{r}^{′}} ; E ) = δ ( \vec{r} - \vec{{r}^{′}} )$$

Where (E+iη) is energy,

$$∇ \cdot \frac{{ℏ}^{2}}{2 {qm}_{x , y , z}^{*} ( \vec{r} )} ∇$$

is a Laplace operator including

$$\frac{{ℏ}^{2}}{2 {qm}_{x , y , z}^{*} ( \vec{r} )} ,$$

ℏ is a reduced Planck constant, m*_{x,y,z}(\vec{r}) is a spatial-related directional effective mass, G(\vec{r}, \vec{r′}; E) is a single-particle Green function corresponding to energy, δ(\vec{r}−\vec{r′}) is a Dirac function; V_{eff}(\vec{r}) is a valid potential energy function, V_{eff}(\vec{r})=−ϕ(\vec{r})+χ₀(\vec{r})+V_{xc}(n(\vec{r})), χ₀(\vec{r}) is a carrier affinity, and V_{xc}(n(\vec{r})) is an exchange-correlation function.

Optionally, n(\vec{r}) is as follows:

n(\vec{r})∫_{μ}_{_{Ea}}_{-Δμ}^{μ}^{_{We}}^{+Δμ}{diag[G(\vec{r},\vec{r′};E)Γ_{We}(E)G⁺(\vec{r},\vec{r′};E)]×ƒ_{We}(μ_{We},E)+diag[G(\vec{r},\vec{r′};E)Γ_{Ea}(E)G⁺(\vec{r},\vec{r′};E)]×ƒ_{Ea}(μ_{Ea,}E)}dE

Where ƒ_{We}(μ_{We}, E) and ƒ_{Ea}(μ_{Ea}, E) are Fermi functions respectively at a port We and a port Ea in the geometric model, μ_{We} and μ_{μ}_{_{Ea}} are electrochemical potentials of the port We and the port Ea, respectively, and Γ_{We}, (E) and Γ_{Ea}(E) are spread functions of the port We and the port Ea, respectively.

Optionally, if the physical simulation model is the model for an open quantum system, the determining a carrier density in the semiconductor device based on the initial condition and/or the boundary condition, and the mathematical physical equation includes: determining a third analytical equation set expressed in a numerical matrix format based on the initial condition and the boundary condition for each of the first control volumes and the Poisson's equation; determining the Green's function equation corresponding to each of the first control volumes to obtain a fourth analytical equation set expressed in a numerical matrix format; determining an initial electrostatic potential; and iteratively solving the fourth analytical equation set based on the initial electrostatic potential and the third analytical equation set to obtain the carrier density in the semiconductor device.

Optionally, the iteratively solving the fourth analytical equation set based on the initial electrostatic potential and the third analytical equation set to obtain the carrier density in the semiconductor device includes: solving the fourth analytical equation set based on the initial electrostatic potential to obtain a first eigenfunction; determining an initial carrier density based on the first eigenfunction; solving the third analytical equation set based on the initial carrier density to obtain a target electrostatic potential; solving the fourth analytical equation set based on the target electrostatic potential to obtain a second eigenfunction; determining a target carrier density based on the second eigenfunction; and if a difference between the target carrier density and the initial carrier density is greater than a preset error, using the target electrostatic potential as a new initial electrostatic potential, and then solving the fourth analytical equation set based on the new initial electrostatic potential to obtain a first eigenfunction; if the difference between the target carrier density and the initial carrier density is less than or equal to the preset error, using the target carrier density as the carrier density in the semiconductor device.

Optionally, after the determining the carrier density in the semiconductor device, the method further includes: determining, based on the carrier density in the semiconductor device, a target region with a carrier density in the geometric model being greater than or equal to a preset threshold; gridding the target region based on a finite volume method, to obtain a plurality of second control volumes, where the second control volume is smaller than the first control volume; and determining a new carrier density in the semiconductor device based on the plurality of second control volumes.

Another embodiment of the present application provides a carrier transport simulation apparatus, and the apparatus includes: a first determining unit, configured to determine a physical simulation model, an initial condition, and/or a boundary condition for carrier transport in a semiconductor device; a second determining unit, configured to determine a mathematical physical equation correspondingly for solving the physical simulation model; and a third determining unit, configured to determine a carrier density in the semiconductor device based on the initial condition and/or the boundary condition, and the mathematical physical equation, to implement a simulation of carrier transport in the semiconductor device.

Another embodiment of the present application provides a carrier transport simulation apparatus, and the apparatus includes: an input determining unit, configured to: determine an initial condition and/or a boundary condition for carrier transport in a semiconductor device, and determine a Poisson's equation corresponding to a model for a semi-classical system; and an output determining unit, configured to determine a carrier density in the semiconductor device based on the initial condition and/or the boundary condition and the Poisson's equation, to implement a simulation of carrier transport in the semiconductor device.

Another embodiment of the present application provides a carrier transport simulation apparatus, and the apparatus includes: an input determining unit, configured to: determine an initial condition and/or a boundary condition for carrier transport in a semiconductor device, and determine a Poisson's equation and a Schrödinger equation that are corresponding to a model for a closed quantum system; and an output determining unit, configured to determine a carrier density in the semiconductor device based on the initial condition and/or the boundary condition, the Poisson's equation, and the Schrödinger equation to implement a simulation of carrier transport in the semiconductor device.

Another embodiment of the present application provides a carrier transport simulation apparatus, and the apparatus includes: an input determining unit, configured to: determine an initial condition and/or a boundary condition for carrier transport in a semiconductor device, and determine a Poisson's equation corresponding to a model for an open quantum system and a Green's function equation corresponding to a Schrödinger equation; and an output determining unit, configured to determine the carrier density in the semiconductor device based on the initial condition and/or the boundary condition, the Poisson's equation, and the Green's function equation corresponding to the Schrödinger equation, to implement the simulation of carrier transport in the semiconductor device.

Another embodiment of the present application provides a non-transitory computer-readable storage medium. The non-transitory computer-readable storage medium stores a computer program. When the computer program is run, the method in embodiments is performed.

Another embodiment of the present application provides an electronic device, including a memory and a processor. The memory stores a computer program. When the processor is configured to run the computer program, the method in embodiments is performed.

In an embodiment, a mathematical physical equation corresponding to different physical simulation models is combined with an initial condition and/or a boundary condition for carrier transport in a semiconductor device, to determine a carrier density in the semiconductor device, so as to implement a simulation of carrier transport in the semiconductor device. This may implement study of carrier transport in a semiconductor device.

### BRIEF DESCRIPTION OF THE DRAWINGS

FIG. 1 is a block diagram of a hardware structure of a computer terminal to which a carrier transport simulation method is applied according to an embodiment.

FIG. 2 is a schematic flowchart of a carrier transport simulation method according to an embodiment.

FIG. 3 is a schematic structural diagram of a first control volume according to an embodiment.

FIG. 4 is a schematic structural diagram of a carrier transport simulation apparatus according to an embodiment.

FIG. 5 is a schematic structural diagram of a carrier transport simulation apparatus according to an embodiment.

### DETAILED DESCRIPTION OF THE EMBODIMENTS

Embodiments described below with reference to the accompanying drawings are exemplary and merely used to explain the present disclosure, but cannot be understood as a limitation on the present disclosure.

An embodiment provides a carrier transport simulation method. The method may be applied to an electronic device, for example, a computer terminal, specifically, a common computer or a quantum computer.

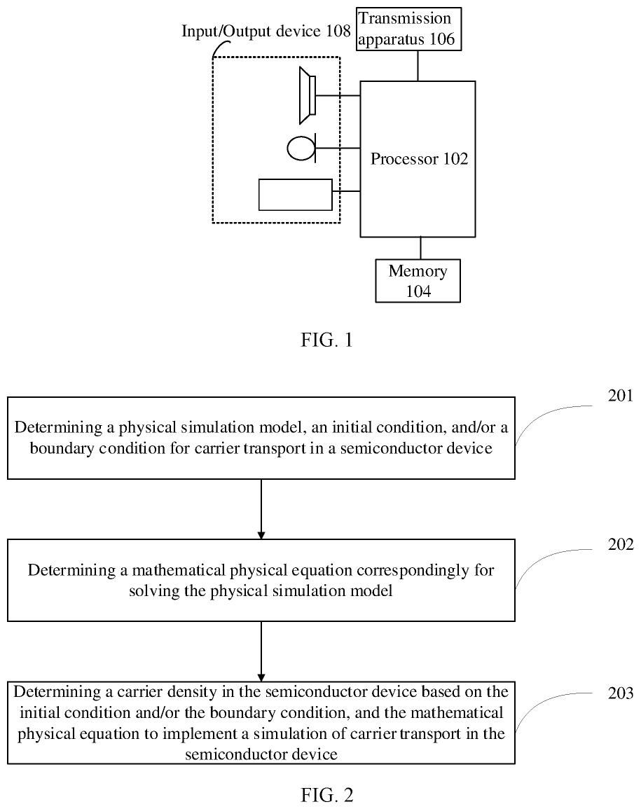

The following describes the method in detail by using an example in which the method is run on a computer terminal. FIG. 1 is a block diagram of a hardware structure of a computer terminal to which a carrier transport simulation method is applied according to an embodiment. As shown in FIG. 1, the computer terminal may include one or more (only one shown in FIG. 1) processors 102 (the processor 102 may include but not limited to a processing apparatus such as a microcontroller unit (Microcontroller Unit, MCU) or a field programmable gate array (Field Programmable Gate Array, FPGA)) and a memory 104 configured to store a carrier transport simulation method. Optionally, the computer terminal may further include a transmission apparatus 106 and an input/output device 108 that are configured to implement a communication function. A person of ordinary skill in the art may understand that the structure shown in FIG. 1 is merely an example and does not constitute any limitation on a structure of the computer terminal. For example, the computer terminal may alternatively include more or fewer components than those shown in FIG. 1, or have a configuration different from that shown in FIG. 1.

The memory 104 may be configured to store a software program and a software module of application software, for example, program instructions/modules corresponding to the carrier transport simulation method in embodiments of the present application. By running the software program and the software module stored in the memory 104, the processor 102 executes various functional applications and data processing, that is, implements the foregoing method. The memory 104 may include a high-speed random access memory, and may further include a non-volatile memory, for example, one or more disk storage apparatus, a flash memory, or another non-volatile solid-state memory. In some embodiments, the memory 104 may further include a memory remotely disposed relative to the processor 102, which may be connected to a computer terminal over a network. Examples of the network include but are not limited to the Internet, a corporate intranet, a local area network, a mobile communication network, and a combination thereof.

The transmission apparatus 106 is configured to receive or send data over a network. A specific example of the network may include a wireless network provided by a communication provider of a computer terminal. In an example, the transmission apparatus 106 includes a network interface controller (Network Interface Controller, NIC). The interface controller may be connected to another network device through a base station to communicate with the Internet. In an example, the transmission apparatus 106 may be a radio frequency (Radio Frequency, RF) module. The radio frequency module is configured to communicate with the Internet in a wireless manner.

It should be noted that a real quantum computer is a hybrid structure that includes two main parts: One is a classical computer responsible for classical computation and control. The other is a quantum device responsible for running quantum programs to implement quantum computation. The quantum program is an instruction sequence that is written in a quantum language such as the QRunes language and that may be run on the quantum computer. In this way, operations of quantum logic gate are supported, and ultimately quantum computation is implemented. Specifically, the quantum program is an instruction sequence through which quantum logic gates are operated in a specific time sequence.

In actual application, limited by the development of hardware of a quantum device, quantum computation simulation often needs to be performed to verify a quantum algorithm, quantum application, and the like. The quantum computation simulation is a process in which virtual architecture (that is, a quantum virtual machine) built by using resources of a common computer realizes simulation of running a quantum program corresponding to a specific problem. Generally, the quantum program corresponding to the specific problem needs to be constructed. The quantum program in this embodiment is a program that is written in a classical language and that indicates qubits and their evolution. Herein, qubits, quantum logic gates, and the like related to quantum computation are all represented by corresponding classical code.

The quantum circuit, as an embodiment of the quantum program, is also known as a quantum logic circuit and is the most commonly used general quantum computation model. The quantum circuit means a circuit that operates qubits from an abstract concept, and includes qubits, lines (timelines), and various quantum logic gates. Finally, a result usually needs to be read through a quantum measurement operation.

A conventional circuit is connected through metallic wires to transmit voltage signals or current signals. Different from the conventional circuit, the quantum circuit may be considered to be connected by time. To be specific, a state of a qubit evolves naturally with time. This process proceeds according to an instruction of the Hamiltonian operator until the qubit is operated by a logic gate.

One quantum program generally corresponds to one total quantum circuit. The quantum program refers to the total quantum circuit. A total quantity of qubits in the total quantum circuit is the same as a total quantity of qubits in the quantum program. It may be understood that one quantum program may include a quantum circuit, a measurement operation for qubits in the quantum circuit, a register for storing a measurement result, and a control flow node (a jump instruction), and one quantum circuit may include tens of or hundreds of or even thousands of quantum logic gate operations. An execution process of the quantum program is a process of executing all quantum logic gates in a specific time sequence. It should be noted that the time sequence is a sequence of time at which an individual quantum logic gate is executed.

It should be noted that in classical computation, the most basic unit is a bit, and the most basic control mode is a logic gate. A purpose of controlling a circuit may be achieved through a combination of logic gates. Similarly, a manner of processing the qubit is to use the quantum logic gate. The use of the quantum logic gate enables the evolution of a quantum state. The quantum logic gate is a base for forming the quantum circuit. The quantum logic gates include single-bit quantum logic gates such as the Hadamard gate (H gate, Hadamard gate), the Pauli-X gate (X gate), the Pauli-Y gate (Y gate), the Pauli-Z gate (Z gate), the RX gate, the RY gate, and the RZ gate; and multi-bit quantum logic gates such as the CNOT gate, the CR gate, the iSWAP gate, or the Toffoli gate. The quantum logic gate is generally represented by using a unitary matrix. The unitary matrix is not only a matrix form but also an operation and a transform. Generally, an action of the quantum logic gate on a quantum state is calculated by left multiplying a unitary matrix by a matrix corresponding to a quantum state ket.

Referring to FIG. 2, FIG. 2 is a schematic flowchart of a carrier transport simulation method according to an embodiment, and the method may include the following steps.

Step 201: Determining a physical simulation model, an initial condition, and/or a boundary condition for carrier transport in a semiconductor device.

The carrier is a carrier of current. In the semiconductor device, the carrier includes two types: an electron and a hole.

For a physical process that changes with time, a state at a specific time affects a process after the specific time, and the state at the specific time is the initial condition. The boundary condition refers to a law of a variable solved on a boundary of a solution region or a derivative of the variable changing with time and location. The boundary condition includes a first type of boundary conditions for a given endpoint value, a second type of boundary conditions for a given gradient value, and a third type of boundary conditions for a given endpoint value and a given gradient value. The boundary condition described herein may be any one of the foregoing three types of boundary conditions, which is not limited herein.

Step 202: Determining a mathematical physical equation correspondingly for solving the physical simulation model.

The mathematical physical equation is used to represent a law of change of a physical quantity in space and time.

The physical simulation model includes at least one of the following: a model for a semi-classical system, a model for a closed quantum system, and a model for an open quantum system. A mathematical physical equation corresponding to the model for a semi-classical system is a Poisson's equation. A mathematical physical equation corresponding to the model for a closed quantum system is a Poisson's equation and a Schrödinger equation. A mathematical physical equation corresponding to the model for an open quantum system is a Poisson's equation and a Green's function equation corresponding to the Schrödinger equation.

Specifically, the Poisson's equation corresponding to the model for a semi-classical system is as follows:

$$∇ \cdot ( - {ε}_{r} ( \vec{r} ) ∇ ) ϕ ( \vec{r} ) = \frac{- q}{{ε}_{0}} ( n ( \vec{r} ) )$$

Where ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density. n(\vec{r}) is as follows:

$$n ( r \vec{r} ) = \frac{\sqrt{{m}_{x}^{*} ( \vec{r} ) {m}_{y}^{*} ( \vec{r} ) {m}_{z}^{*} ( \vec{r} )}}{{π}^{3 / 2} {ℏ}^{3}} {( {K}_{B} T )}^{3 / 2} {F}_{1 / 2} ( \frac{μ ( \vec{r} ) - {E}_{c} ( \vec{r} )}{{K}_{B} T / q} )$$

Where m*ₓ(\vec{r}), m*_{y}(\vec{r}), and m*_{z}(\vec{r}) are spatial-related directional effective masses, ℏ is a reduced Planck constant, K_{B} is a Boltzmann constant, T is a temperature in a unit of Kelvin, F_{1/2} is a half-order Fermi-Dirac integral, μ(\vec{r}) is an electrochemical potential, E_{C}(\vec{r}) is an energy at a conduction band edge, E_{c}(\vec{r})=−eϕ(\vec{r})χ₀(\vec{r}), e is an elementary charge, and χ₀(\vec{r}) is a carrier affinity.

Specifically, the Poisson's equation corresponding to the model for a closed quantum system is as follows:

$$∇ \cdot ( - {ε}_{r} ( \vec{r} ) ∇ ) ϕ ( \vec{r} ) = \frac{- q}{{ε}_{0}} ( n ( \vec{r} ) )$$

Where ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density.

The Schrödinger equation corresponding to the model for a closed quantum system is as follows:

$$[ - ∇ \cdot \frac{{ℏ}^{2}}{2 {qm}_{x , y , z}^{*} ( \vec{r} )} ∇ + {V}_{eff} ( \vec{r} ) ] {ψ}_{i} ( \vec{r} ) = {e}_{i} {ψ}_{i} ( \vec{r} )$$

Where

$$∇ \cdot \frac{{ℏ}^{2}}{2 {qm}_{x , y , z}^{*} ( \vec{r} )} ∇$$

is a Laplace operator including

$$\frac{{ℏ}^{2}}{2 {qm}_{x , y , z}^{*} ( \vec{r} )} ,$$

ℏ is a reduced Planck constant, m*_{x,y,z}(\vec{r}) is a spatial-related directional effective mass, eᵢ and ψᵢ(\vec{r}) are an eigenvalue and an eigenfunction of a closed quantum system, respectively, V_{eff}(\vec{r}) is a valid potential energy function, V_{eff}(\vec{r})=−ϕ(\vec{r})+χ₀(\vec{r})+V_{xc}(n(\vec{r})), χ₀(\vec{r}) is a carrier affinity, and V_{xc}(n(\vec{r})) is an exchange-correlation function.

n(\vec{r}) is as follows:

$$n ( \vec{r} ) = {\sum }_{i} {f}_{F} ( {e}_{i} ) {ψ}_{i} ( \vec{r} ) {ψ}_{i}^{+} ( \vec{r} ) = {\sum }_{i} \frac{1}{1 + exp ( ( {e}_{i} - μ ( \vec{r} ) ) / {V}_{T} )} {ψ}_{i} ( \vec{r} ) {ψ}_{i}^{+} ( \vec{r} )$$

Where ƒ_{F}(eᵢ) is a Fermi function, V_{T} is a carrier thermal voltage, V_{T}=K_{B}T/q, μ(\vec{r}) is an electrochemical potential, K_{B} is a Boltzmann constant, and T is a temperature in a unit of Kelvin.

It should be noted that solving the model for a closed quantum system requires simultaneous Poisson's equation and Schrödinger equation. The carrier density herein is not an expression of the carrier density in the model for a semi-classical system, but is an expression of the carrier density in the model for a closed quantum system.

Specifically, the Poisson's equation corresponding to the model for an open quantum system is as follows:

$$∇ \cdot ( - {ε}_{r} ( \vec{r} ) ∇ ) ϕ ( \vec{r} ) = \frac{- q}{{ε}_{0}} ( n ( \vec{r} ) )$$

Where ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density.

The Green's function equation corresponding to the model for an open quantum system is as follows:

$$( ( E + i η ) - ( - ∇ \cdot \frac{{ℏ}^{2}}{2 {qm}_{x , y , z}^{*} ( \vec{r} )} ∇ + {V}_{eff} ( \vec{r} ) ) ) G ( \vec{r} , \vec{{r}^{′}} ; E ) = δ ( \vec{r} - \vec{{r}^{′}} )$$

Where (E+iη) is energy,

$$∇ \cdot \frac{{ℏ}^{2}}{2 {qm}_{x , y , z}^{*} ( \vec{r} )} ∇$$

is a Laplace operator including

$$\frac{{ℏ}^{2}}{2 {qm}_{x , y , z}^{*} ( \vec{r} )} ,$$

ℏ is a reduced Planck constant, m*_{x,y,z}(\vec{r}) is a spatial-related directional effective mass, G(\vec{r}, \vec{r′}; E) is a single-particle Green function corresponding to energy, δ(\vec{r}−\vec{r′}) is a Dirac function; V_{eff}(\vec{r}) is a valid potential energy function, V_{eff}(\vec{r})=−ϕ(\vec{r})+χ₀(\vec{r})+V_{xc}(n(\vec{r})), χ₀(\vec{r}) is a carrier affinity, and V_{xc}(n(\vec{r})) is an exchange-correlation function.

n(\vec{r}) is as follows:

n(\vec{r})∫_{μ}_{_{Ea}}_{-Δμ}^{μ}^{_{We}}^{+Δμ}{diag[G(\vec{r},\vec{r′};E)Γ_{We}(E)G⁺(\vec{r},\vec{r′};E)]×ƒ_{We}(μ_{We},E)+diag[G(\vec{r},\vec{r′};E)Γ_{Ea}(E)G⁺(\vec{r},\vec{r′};E)]×ƒ_{Ea}(μ_{Ea,}E)}dE

Where ƒ_{We}(μ_{We}, E) and ƒ_{Ea}(μ_{Ea}, E) are Fermi functions respectively at a port We and a port Ea in the geometric model, μ_{We} and μ_{μ}_{_{Ea}} are electrochemical potentials of the port We and the port Ea, respectively, and Γ_{We}, (E) and Γ_{Ea}(E) are spread functions of the port We and the port Ea, respectively.

Similarly, it should be noted that solving the model for an open quantum system also requires simultaneous Poisson's equation and Green's function equation. The carrier density herein is not an expression of the carrier density in the model for a semi-classical system or the model for a closed quantum system, but is an expression of the carrier density in the foregoing model for an open quantum system.

In the foregoing three models, ε_{T}(\vec{r}), ε₀, and q are all known parameters, and εᵣ(\vec{r}) is related to a property of a material at \vec{r} of a semiconductor device. For example, if a same material is isotropic, εᵣ of Si is 11.8, εᵣ of GaAs is 12.8, εᵣ of 4H—SiC is 9.7, and εᵣ of GaN is 9. ε₀=8.854187817×10⁻¹² F/m, q=1.6×10⁻¹⁹ C, and K_{B}=1.380649×10⁻²³ J/K. μ(\vec{r}) is related to an input excitation voltage V and a position, and eV formed by an electron e and a voltage V is a unit of energy. For an isotropic semiconductor device, directional effective masses in all directions of space are equal, that is, m*ₓ(\vec{r})=m*_{y}(\vec{r})=m*_{z}(\vec{r}). For an anisotropic semiconductor device, a directional effective mass is related to a property of a physical material at its location.

Step 203: Determining a carrier density in the semiconductor device based on the initial condition and/or the boundary condition, and the mathematical physical equation, to implement a simulation of carrier transport in the semiconductor device.

Specifically, the determining an initial condition and/or a boundary condition for carrier transport in a semiconductor device includes: constructing a geometric model of the semiconductor device; gridding the geometric model based on a finite volume method to obtain a plurality of first control volumes; and determining an initial condition and/or a boundary condition for each of the first control volumes.

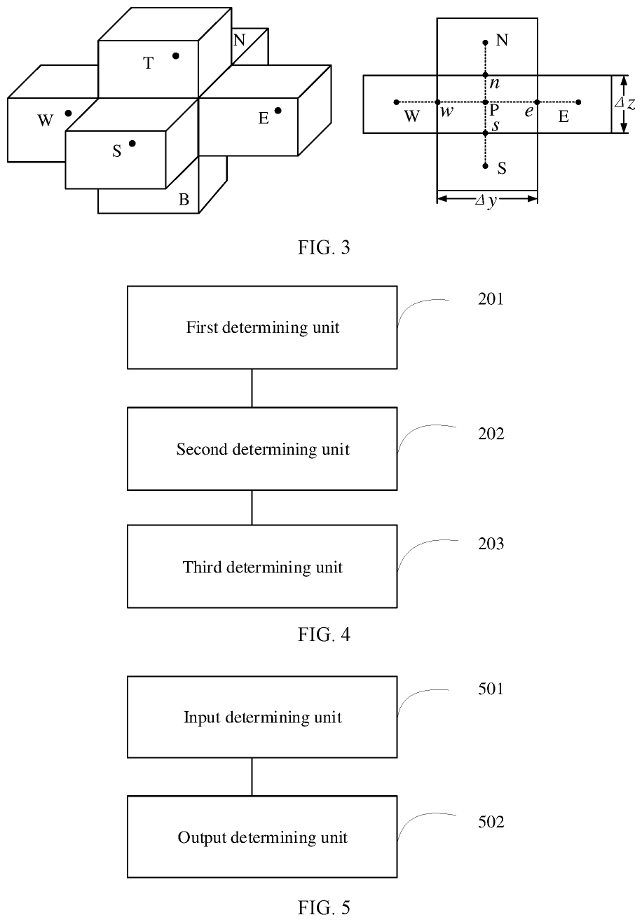

For example, FIG. 3 is a schematic structural diagram of a first control volume according to an embodiment. The left part of FIG. 3 is a three-dimensional perspective view of a first control volume according to an embodiment; and the right part of FIG. 3 is a two-dimensional plan view of a first control volume according to an embodiment. As shown in the left part of FIG. 3, centers of the west, east, north, south, bottom, and top of the center P (not shown in the figure) of the first control volume are W, E, N, S, B, and T, respectively. As shown in the right part of FIG. 3, w, e, n, s, b, and t are respectively center points corresponding to interfaces between the center P of the first control volume and W, E, N, S, B, and T. A length Δx of P is [b, t], a width Δy of P is [w, e], a height Δz of P is [s, n], and a volume of P is D_{P}=[b, t]×[w, e]×[s, n], where b, t, and Δx are not shown.

It should be noted that, a geometric model is divided into a plurality of first control volumes that are similar to P, and all first control volumes may be equal or may be different. Generally, a boundary condition exists only for a first control volume at an endpoint (or an edge), and there is no boundary condition for another first control volume in the geometric model.

It may be learned that a geometric model may be divided into a plurality of control volumes by using a finite volume method, so that it is convenient to construct a discrete equation of a mathematical physical equation subsequently by using a conservation equation expressed in an integral form, thereby obtaining a solution of the mathematical physical equation.

Specifically, if the physical simulation model is the model for a semi-classical system, the determining the carrier density in the semiconductor device based on the initial condition and/or the boundary condition, and the mathematical physical equation (namely, a Poisson's equation) includes: determining an analytical equation set expressed in a numerical matrix format based on the initial condition and/or the boundary condition for each of the first control volumes and the Poisson's equation; transforming the analytical equation set expressed in a numerical matrix format into an analytical equation set expressed in a form of residuals; solving the analytical equation set expressed in a form of residuals based on a Newton iteration algorithm to obtain a first electrostatic potential; and determining the carrier density in the semiconductor device based on the first electrostatic potential.

For example, after gridding, a discrete Laplace operator that includes a parameter (αₓ, α_{y}, α_{z}) is as follows:

$$\frac{d}{dx} ( {α}_{x} \frac{d}{dx} ) + \frac{d}{dy} ( {α}_{y} \frac{d}{dy} ) + \frac{d}{dz} ( {α}_{z} \frac{d}{dz} )$$

For P in FIG. 3, a basic property of a definite integral is as follows:

$$\int \int {\int }_{{D}_{p}} \frac{d}{dx} ( {α}_{x} \frac{d ϕ}{dx} ) + \frac{d}{dy} ( {α}_{y} \frac{d ϕ}{dy} ) + \frac{d}{dz} ( {α}_{z} \frac{d ϕ}{dz} ) dxdydz = \int \int {\int }_{{D}_{p}} \frac{d}{dx} ( {α}_{x} \frac{d ϕ}{dx} ) dxdydz + \int \int {\int }_{{D}_{p}} \frac{d}{dy} ( {α}_{y} \frac{d ϕ}{dy} ) dxdydz \int \int {\int }_{{D}_{p}} \frac{d}{dz} ( {α}_{z} \frac{d ϕ}{dz} ) dxdydz = \int {\int }_{[ w , e ] \times [ s , n ]} {[ {α}_{x} \frac{d ϕ}{dx} ]}_{t} - {[ {α}_{x} \frac{d ϕ}{dx} ]}_{b} dydz + \int {\int }_{[ b , t ] \times [ s , n ]} {[ {α}_{y} \frac{d ϕ}{dy} ]}_{e} - {[ {α}_{y} \frac{d ϕ}{dy} ]}_{w} dxdz + \int {\int }_{[ b , t ] \times [ w , e ]} {[ {α}_{z} \frac{d ϕ}{dz} ]}_{n} - {[ {α}_{z} \frac{d ϕ}{dz} ]}_{s} dxdy$$

The foregoing formula is converted by integral average into:

$$( {[ {α}_{x} \frac{d ϕ}{dx} ]}_{t} - {[ {α}_{x} \frac{d ϕ}{dx} ]}_{b} ) Δ y Δ z + ( {[ {α}_{y} \frac{d ϕ}{dy} ]}_{e} - {[ {α}_{y} \frac{d ϕ}{dy} ]}_{w} ) Δ x Δ z + ( {[ {α}_{z} \frac{d ϕ}{dz} ]}_{n} - {[ {α}_{z} \frac{d ϕ}{dz} ]}_{s} ) Δ x Δ y$$

Central difference approximation is computed by first-order as follows:

$$( {[ {α}_{x} ]}_{t} [ \frac{{ϕ}_{T} - {ϕ}_{P}}{{δ}_{{x}_{t}}} ] - {[ {α}_{x} ]}_{b} [ \frac{{ϕ}_{P} - {ϕ}_{B}}{{δ}_{{x}_{b}}} ] ) Δ y Δ z + ( {[ {α}_{y} ]}_{e} [ \frac{{ϕ}_{E} - {ϕ}_{P}}{{δ}_{{y}_{e}}} ] - {[ {α}_{y} ]}_{w} [ \frac{{ϕ}_{P} - {ϕ}_{W}}{{δ}_{{y}_{w}}} ] ) Δ x Δ z + ( {[ {α}_{z} ]}_{n} [ \frac{{ϕ}_{N} - {ϕ}_{P}}{{δ}_{{z}_{n}}} ] - {[ {α}_{z} ]}_{s} [ \frac{{ϕ}_{P} - {ϕ}_{W}}{{δ}_{{z}_{s}}} ] ) Δ x Δ y$$

Thus, a formula may be obtained as follows:

$$\frac{1}{Δ x Δ y Δ z} \int \int {\int }_{{D}_{p}} \frac{d}{dx} ( {α}_{x} \frac{d ϕ}{dx} ) + \frac{d}{dy} ( {α}_{y} \frac{d ϕ}{dy} ) + \frac{d}{dz} ( {α}_{z} \frac{d ϕ}{dz} ) dxdydz \approx \frac{1}{Δ x Δ y Δ z} \{ ( {[ {α}_{x} ]}_{t} [ \frac{{ϕ}_{T} - {ϕ}_{P}}{{δ}_{{x}_{t}}} ] - {[ {α}_{x} ]}_{b} [ \frac{{ϕ}_{P} - {ϕ}_{B}}{{δ}_{{x}_{b}}} ] ) Δ y Δ z + ( {[ {α}_{y} ]}_{e} [ \frac{{ϕ}_{E} - {ϕ}_{P}}{{δ}_{{y}_{e}}} ] - {[ {α}_{y} ]}_{w} [ \frac{{ϕ}_{P} - {ϕ}_{W}}{{δ}_{{y}_{w}}} ] ) Δ x Δ z + ( {[ {α}_{z} ]}_{n} [ \frac{{ϕ}_{N} - {ϕ}_{P}}{{δ}_{{z}_{n}}} ] - {[ {α}_{z} ]}_{s} [ \frac{{ϕ}_{P} - {ϕ}_{S}}{{δ}_{{z}_{s}}} ] ) Δ x Δ y \} = ( \frac{{[ {α}_{x} ]}_{t}}{{δ}_{{x}_{t}} Δ x} ) {ϕ}_{T} + ( \frac{{[ {α}_{x} ]}_{b}}{{δ}_{{x}_{b}} Δ x} ) {ϕ}_{B} + ( \frac{{[ {α}_{y} ]}_{e}}{{δ}_{{y}_{e}} Δ y} ) {ϕ}_{E} + ( \frac{{[ {α}_{y} ]}_{w}}{{δ}_{{y}_{w}} Δ y} ) {ϕ}_{W} + ( \frac{{[ {α}_{z} ]}_{n}}{{δ}_{{z}_{n}} Δ z} ) {ϕ}_{N} + ( \frac{{[ {α}_{z} ]}_{s}}{{δ}_{{z}_{s}} Δ z} ) {ϕ}_{S} - ( \frac{{[ {α}_{x} ]}_{t}}{{δ}_{{x}_{t}} Δ x} + \frac{{[ {α}_{x} ]}_{b}}{{δ}_{{x}_{b}} Δ x} + \frac{{[ {α}_{y} ]}_{e}}{{δ}_{{y}_{e}} Δ y} + \frac{{[ {α}_{y} ]}_{w}}{{δ}_{{y}_{w}} Δ y} + \frac{{[ {α}_{z} ]}_{n}}{{δ}_{{z}_{n}} Δ z} + ) {ϕ}_{P}$$

Where [αₓ]_{b,t}, [α_{y}]_{w,e}, [α_{z}]_{s,n} may be obtained through computing by using flux conservation.

Definition is as follows:

$${β}_{b , t} ≡ \frac{{[ {α}_{z} ]}_{b , t}}{{δ}_{{x}_{b , t}} Δ x} , {β}_{w , e} ≡ \frac{{[ {α}_{y} ]}_{w , e}}{{δ}_{{y}_{w , e}} Δ y} , {β}_{s , n} ≡ \frac{{[ {α}_{z} ]}_{s , n}}{{δ}_{{z}_{s , n}} Δ z} , \\ {β}_{p} ≡ \frac{{[ {α}_{x} ]}_{t}}{{δ}_{{x}_{t}} Δ x} + \frac{{[ {α}_{x} ]}_{b}}{{δ}_{{x}_{b}} Δ x} + \frac{{[ {α}_{y} ]}_{e}}{{δ}_{{y}_{e}} Δ y} + \frac{{[ {α}_{y} ]}_{w}}{{δ}_{{y}_{w}} Δ y} + \frac{{[ {α}_{z} ]}_{n}}{{δ}_{{z}_{n}} Δ z}$$

Therefore, the foregoing formula may be abbreviated as:

$$\frac{1}{Δ x Δ y Δ z} \int \int {\int }_{{D}_{p}} \frac{d}{dx} ( {α}_{x} \frac{d ϕ}{dx} ) + \frac{d}{dy} ( {α}_{y} \frac{d ϕ}{dy} ) + \frac{d}{dz} ( {α}_{z} \frac{d ϕ}{dz} ) dxdydz = {β}_{t} {ϕ}_{T} + {β}_{b} {ϕ}_{B} + {β}_{e} {ϕ}_{E} + {β}_{w} {ϕ}_{W} + {β}_{n} {ϕ}_{N} + {β}_{s} {ϕ}_{S} - {β}_{p} {ϕ}_{P}$$

For the Poisson's equation:

αₓ=−‰ₓ,α_{y}=−ε_{y},α_{z}=−ε_{z}

For a plurality of first control volumes (CV) that are gridded, the plurality of foregoing equations may be obtained, and the plurality of foregoing equations are converted into an analytical equation set expressed in a numerical matrix format as follows:

$$[ M ] \overline{ϕ} = {\vec{R}}_{Bo} - \frac{q}{{ε}_{0}} \overline{n} ( \overline{ϕ} )$$

Where an analytical function ϕ(\vec{r}) is discretized into a column vector ϕ̅, and \vec{R}_{Bo} is a vector fixed from a boundary condition. [M] is a 7-diagonal matrix of βᵢ (where i=p, t, b, e, w, n, s), and n̅(ϕ̅) is a nonlinear function of ϕ̅. An equation set expressed in a form of residuals is expressed as follows:

$$d ( \overline{ϕ} ) = [ M ] \overline{ϕ} - {\vec{R}}_{Bo} + \frac{q}{{ε}_{0}} \overline{n} ( \overline{ϕ} )$$

The equation set expressed in a form of residuals may be solved by using a Newton iteration method, and the Newton iteration method is as follows:

$${\overline{ϕ}}^{k + 1} = {\overline{ϕ}}^{k} - {[ J ]}^{- 1} d ( {\overline{ϕ}}^{k} ) , J = [ M ] + \frac{q}{{ε}_{0}} \frac{\partial \overline{n} ( \overline{ϕ} )}{\partial \overline{ϕ}}$$

Where J is a Jacobian matrix; and ϕ̅⁰ is a given initial value. A numerical solution of the foregoing relationship may be computed by continuous iteration until convergence, so as to obtain the first electrostatic potential.

It may be learned that, for a nonlinear Poisson's equation, a discrete equation set is first written into an analytical equation set expressed in a numerical matrix format, then the analytical equation set expressed in a numerical matrix format is transformed into an analytical equation set expressed in a form of residuals, and finally the analytical equation set expressed in a form of residuals is solved by using a Newton iteration algorithm, so as to determine a potential.

Further, the first electrostatic potential, as an electrostatic potential to be determined, is substituted into n(\vec{r}) to obtain the carrier density in the semiconductor device.

The first electrostatic potential, as ϕ(\vec{r}), is substituted into E_{c}(\vec{r})=−eϕ(\vec{r})χ₀(\vec{r}), and thus a formula may be obtained as follows:

$$n ( \vec{r} ) = \frac{\sqrt{{m}_{x}^{*} ( \vec{r} ) {m}_{y}^{*} ( \vec{r} ) {m}_{z}^{*} ( \vec{r} )}}{{π}^{3 / 2} {ℏ}^{3}} {( {K}_{B} T )}^{3 / 2} {T}_{1 / 2} ( \frac{μ ( \vec{r} ) - {E}_{c} ( \vec{r} )}{{K}_{B} T / q} )$$

In another specific embodiment, a target region with an electrostatic potential density in the geometric model being greater than or equal to a preset threshold is determined based on the first electrostatic potential. The target region is gridded based on a finite volume method, to obtain a plurality of second control volumes, where the second control volume is smaller than the first control volume. A second electrostatic potential is determined based on the plurality of second control volumes, where spatial distribution accuracy of the second electrostatic potential is higher than spatial distribution accuracy of the first electrostatic potential. The second electrostatic potential as the electrostatic potential to be determined is substituted into n(\vec{r}) to obtain the carrier density in the semiconductor device.

It should be noted that the preset threshold is preset. A method for determining the second electrostatic potential may be the same as a solution manner in the foregoing model for a semi-classical system (a Poisson's equation continues to be used), or another manner may be used.

It may be learned that a large first control volume is obtained by first meshing the geometric model based on the finite volume method. In this way, a small quantity of discrete equations is obtained, and a dimension of a discrete equation set is also relatively small, so that an approximate potential value may be quickly obtained. Then, a target region with a relatively large potential value is found based on the approximate potential value, and the target region is re-meshed to obtain a relatively small second control volume. Because not all regions of the geometric model are meshed, a dimension of the discrete equation set may still be kept relatively small, so as to obtain an accurate potential value of the region. A quantity of fitting points in a region with a relatively low potential has little effect on fitting accuracy, and a quantity of fitting points in a region with a relatively high potential has a great effect on fitting accuracy. Herein, a relatively small quantity of fitting points is used for a non-target region with a relatively low potential (the first control volume is larger than the second control volume, and a size of the non-target region of the geometric model is unchanged, so that compared with the second gridding, there are fewer fitting points after this gridding). A relatively large quantity of fitting points is used for a target region with a relatively high potential (the second control volume is smaller than the first control volume, and the size of the target region of the geometric model is unchanged, so that compared with the first gridding, there are more fitting points after this gridding). In this way, spatial distribution accuracy of the potential is improved, and a computing speed is also ensured.

In still another specific embodiment, the target region with a carrier density in the geometric model being greater than or equal to a preset threshold is determined based on the carrier density obtained through solving. The target region is gridded based on a finite volume method, to obtain a plurality of third control volumes, where the third control volume is smaller than the first control volume. Anew carrier density is determined based on the plurality of third control volumes, and the new carrier density is used as the carrier density in the semiconductor device.

It should be noted that, the preset threshold and the target region in this embodiment may be the same as or different from the preset threshold and the target region in the previous embodiment. For distinction, for example, the preset threshold in the previous embodiment is a first preset threshold, and the target region is a first target region. The preset threshold in this embodiment is a second preset threshold, and the target region is a second target region.

It should be further noted that in this embodiment, a new carrier density may be determined, for example, by using a Poisson's equation, or may be determined by using a Poisson's equation and a Schrödinger equation. For different physical simulation models, forms of the Schrödinger equation are different. For example, a form of the Schrödinger equation corresponding to a model for an open quantum system is different from a form of the Schrödinger equation corresponding to a model for a closed quantum system.

The following uses an example in which a carrier density in a model for an open quantum system is solved. Specific steps are as follows.

Determining an initial condition and/or a boundary condition for each of the third control volumes; determining a Schrödinger equation corresponding to a model for an open quantum system; and determining a second electrostatic potential based on the initial condition and/or the boundary condition for each of the third control volumes, and the Schrödinger equation.

Where the initial condition and/or the boundary condition for the third control volume may be the same as or different from the initial condition and/or the boundary condition for the first control volume, which is not limited herein.

The Schrödinger equation is as follows:

$$( ( E + i η ) - ( - ∇ \cdot \frac{{ℏ}^{2}}{2 {qm}_{x , y , z}^{*} ( \vec{r} )} ∇ + {V}_{eff} ( \vec{r} ) ) ) G ( \vec{r} , \vec{{r}^{′}} ; E ) = δ ( \vec{r} - \vec{{r}^{′}} )$$

Where (E+iη) is energy,

$$∇ \cdot \frac{{ℏ}^{2}}{2 {qm}_{i} ( \vec{r} )} ∇$$

is a Laplace operator including

$$\frac{{ℏ}^{2}}{2 {qm}_{x , y , z}^{*} ( \vec{r} )} ,$$

ℏ is a reduced Planck constant,

$$\frac{{ℏ}^{2}}{2 {qm}_{x , y , z}^{*} ( \vec{r} )}$$

is a spatial-related directional effective mass, G(\vec{r}, \vec{r′}; E) is a single-particle Green function corresponding to energy, δ(\vec{r}−\vec{r′}) is a Dirac function; V_{eff}(\vec{r}) is a valid potential energy function, V_{eff}(\vec{r})=−ϕ(\vec{r})+χ₀(\vec{r})+V_{xc}(n(\vec{r})), χ₀(\vec{r}) is a carrier affinity, and V_{xc}(n(\vec{r})) is an exchange-correlation function. ϕ′(\vec{r}) is a second electrostatic potential, and n′(\vec{r}) is a carrier density in a model for an open quantum system.

n′(\vec{r}) is as follows:

n′(\vec{r})∫_{μ}_{_{Ea}}_{-Δμ}^{μ}^{_{We}}^{+Δμ}{diag[G(\vec{r},\vec{r′};E)Γ_{We}(E)G⁺(\vec{r},\vec{r′};E)]×ƒ_{We}(μ_{We},E)+diag[G(\vec{r},\vec{r′};E)Γ_{Ea}(E)G⁺(\vec{r},\vec{r′};E)]×ƒ_{Ea}(μ_{Ea,}E)}dE.

Where ƒ_{We}(μ_{We}, E) and ƒ_{Ea}(μ_{Ea}, E) are Fermi functions respectively at a port We and a port Ea in the geometric model, μ_{We} and μ_{Ea} are electrochemical potentials of the port We and the port Ea, respectively, and Γ_{We}, (E) and Γ_{Ea}(E) are spread functions of the port We and the port Ea, respectively.

The second electrostatic potential ϕ′(\vec{r}) may be obtained by means of solution in the foregoing method, then ϕ′(\vec{r}), as ϕ(\vec{r}), is substituted into E_{c}(\vec{r})=−eϕ(\vec{r})χ₀(\vec{r}), and thus a formula may be obtained as follows:

$$n ( \vec{r} ) = \frac{\sqrt{{m}_{x}^{*} ( \vec{r} ) {m}_{y}^{*} ( \vec{r} ) {m}_{z}^{*} ( \vec{r} )}}{{π}^{3 / 2} {ℏ}^{3}} {( {K}_{B} T )}^{3 / 2} {F}_{1 / 2} ( \frac{μ ( \vec{r} ) - {E}_{c} ( \vec{r} )}{{K}_{B} T / q} )$$

In the carrier transport simulation method, a Poisson's equation corresponding to a model for a semi-classical system is combined with an initial condition and/or a boundary condition for carrier transport in a semiconductor device, to determine a carrier density in the semiconductor device, so as to implement a simulation of carrier transport in the semiconductor device, and further implement research on carrier transport in the semiconductor device.

Specifically, if the physical simulation model is the model for a closed system, the determining the carrier density in the semiconductor device based on the initial condition and/or the boundary condition, and the mathematical physical equation (namely, the Poisson's equation and the Schrödinger equation) includes: determining a first analytical equation set expressed in a numerical matrix format based on the initial condition and the boundary condition for each of the first control volumes and the Poisson's equation; determining the Schrödinger equation corresponding to each of the first control volumes to obtain a second analytical equation set expressed in a numerical matrix format; determining an initial carrier density; and iteratively solving the second analytical equation set based on the initial carrier density and the first analytical equation set to obtain the carrier density in the semiconductor device.

For example, after gridding, a discrete Laplace operator that includes a parameter (αₓ, α_{y}, α_{z}) is as follows:

$$\frac{d}{dx} ( {α}_{x} \frac{d}{dx} ) + \frac{d}{dy} ( {α}_{y} \frac{d}{dy} ) + \frac{d}{dz} ( {α}_{z} \frac{d}{dz} )$$

For P in FIG. 3, a basic property of a definite integral is as follows:

$$\int \int {\int }_{{D}_{p}} \frac{d}{dx} ( {α}_{x} \frac{d}{dx} ) + \frac{d}{dy} ( {α}_{y} \frac{d}{dy} ) + \frac{d}{dz} ( {α}_{z} \frac{d}{dz} ) dxdydz = \int \int {\int }_{{D}_{p}} \frac{d}{dx} ( {α}_{x} \frac{d}{dx} ) dxdydz + \int \int {\int }_{{D}_{p}} \frac{d}{dy} ( {α}_{y} \frac{d}{dy} ) dxdydz + \int \int {\int }_{{D}_{p}} \frac{d}{dz} ( {α}_{z} \frac{d}{dz} ) dxdydz = \int {\int }_{w , e ] \times [ s , n ]} {[ {α}_{x} \frac{d ϕ}{dx} ]}_{t} - {[ {α}_{x} \frac{d ϕ}{dx} ]}_{b} dydz + \\ \int {\int }_{[ b , t ] \times [ s , n ]} {[ {α}_{y} \frac{d ϕ}{dy} ]}_{e} - {[ {α}_{y} \frac{d ϕ}{dy} ]}_{w} dxdz + \int {\int }_{[ b , t ] \times [ w , e ]} {[ {α}_{z} \frac{d ϕ}{dz} ]}_{n} - {[ {α}_{z} \frac{d ϕ}{dz} ]}_{s} dxdy$$

The foregoing formula is converted by integral average into:

$$( {[ {α}_{x} \frac{d ϕ}{dx} ]}_{t} - {[ {α}_{x} \frac{d ϕ}{dx} ]}_{b} ) Δ y Δ z + ( {[ {α}_{y} \frac{d ϕ}{dy} ]}_{e} - {[ {α}_{y} \frac{d ϕ}{dy} ]}_{w} ) Δ x Δ z + ( {[ {α}_{z} \frac{d ϕ}{dz} ]}_{n} - {[ {α}_{z} \frac{d ϕ}{dz} ]}_{s} ) Δ x Δ y$$

Central difference approximation is computed by first-order as follows:

$$( {[ {α}_{x} ]}_{t} [ \frac{{ϕ}_{T} - {ϕ}_{P}}{{δ}_{{x}_{t}}} ] - {[ {α}_{x} ]}_{b} [ \frac{{ϕ}_{P} - {ϕ}_{B}}{{δ}_{{x}_{b}}} ] ) Δ y Δ z + ( {[ {α}_{y} ]}_{e} [ \frac{{ϕ}_{E} - {ϕ}_{P}}{{δ}_{{y}_{e}}} ] - {[ {α}_{y} ]}_{w} [ \frac{{ϕ}_{P} - {ϕ}_{W}}{{δ}_{{y}_{w}}} ] ) Δ x Δ z + ( {[ {α}_{z} ]}_{n} [ \frac{{ϕ}_{N} - {ϕ}_{P}}{{δ}_{{z}_{n}}} ] - {[ {α}_{z} ]}_{s} [ \frac{{ϕ}_{P} - {ϕ}_{W}}{{δ}_{{z}_{s}}} ] ) Δ x Δ y$$

Thus, a formula may be obtained as follows:

$$\frac{1}{Δ x Δ y Δ z} \int \int {\int }_{{D}_{p}} \frac{d}{dx} ( {α}_{x} \frac{d}{dx} ) + \frac{d}{dy} ( {α}_{y} \frac{d}{dy} ) + \frac{d}{dz} ( {α}_{z} \frac{d}{dz} ) dxdydz \approx \frac{1}{Δ x Δ y Δ z} \{ ( {[ {α}_{x} ]}_{t} [ \frac{{ϕ}_{T} - {ϕ}_{P}}{{δ}_{{x}_{t}}} ] - {[ {α}_{x} ]}_{b} [ \frac{{ϕ}_{P} - {ϕ}_{B}}{{δ}_{{x}_{b}}} ] ) Δ y Δ z + ( {[ {α}_{y} ]}_{e} [ \frac{{ϕ}_{E} - {ϕ}_{P}}{{δ}_{{y}_{e}}} ] - {[ {α}_{y} ]}_{w} [ \frac{{ϕ}_{P} - {ϕ}_{W}}{{δ}_{{y}_{w}}} ] ) Δ x Δ z + ( {[ {α}_{z} ]}_{n} [ \frac{{ϕ}_{N} - {ϕ}_{P}}{{δ}_{{z}_{n}}} ] - {[ {α}_{z} ]}_{s} [ \frac{{ϕ}_{P} - {ϕ}_{W}}{{δ}_{{z}_{s}}} ] ) Δ x Δ y \} = ( \frac{{[ {α}_{x} ]}_{t}}{{δ}_{{x}_{t}} Δ x} ) {ϕ}_{T} + ( \frac{{[ {α}_{x} ]}_{b}}{{δ}_{{x}_{b}} Δ x} ) {ϕ}_{B} + ( \frac{{[ {α}_{y} ]}_{e}}{{δ}_{{y}_{e}} Δ y} ) {ϕ}_{E} + ( \frac{{[ {α}_{y} ]}_{w}}{{δ}_{{y}_{w}} Δ y} ) {ϕ}_{W} + ( \frac{{[ {α}_{z} ]}_{n}}{{δ}_{{z}_{n}} Δ z} ) {ϕ}_{N} + ( \frac{{[ {α}_{z} ]}_{s}}{{δ}_{{z}_{s}} Δ z} ) {ϕ}_{S} - ( \frac{{[ {α}_{x} ]}_{t}}{{δ}_{{x}_{t}} Δ x} + \frac{{[ {α}_{x} ]}_{b}}{{δ}_{{x}_{b}} Δ x} + \frac{{[ {α}_{y} ]}_{e}}{{δ}_{{y}_{e}} Δ y} + \frac{{[ {α}_{y} ]}_{w}}{{δ}_{{y}_{w}} Δ y} + \frac{{[ {α}_{z} ]}_{n}}{{δ}_{{z}_{n}} Δ z} + \frac{{[ {α}_{z} ]}_{s}}{{δ}_{{z}_{s}} Δ z} ) {ϕ}_{P}$$

where [αₓ]_{b,t}, [α_{y}]_{w,e}, [α_{z}]_{s,n} may be obtained through computing by using flux conservation.

Definition is as follows:

$${β}_{b , t} ≡ \frac{{[ {α}_{x} ]}_{b , t}}{{δ}_{{x}_{b , t}} Δ x} , {β}_{w , e} ≡ \frac{{[ {α}_{y} ]}_{w , e}}{{δ}_{{y}_{w , e}} Δ y} , {β}_{s , n} ≡ \frac{{[ {α}_{z} ]}_{s , n}}{{δ}_{{z}_{s , n}} Δ z} , \\ {β}_{P} ≡ \frac{{[ {α}_{x} ]}_{t}}{{δ}_{{x}_{t}} Δ x} + \frac{{[ {α}_{x} ]}_{b}}{{δ}_{{x}_{b}} Δ x} + \frac{{[ {α}_{y} ]}_{e}}{{δ}_{{y}_{e}} Δ y} + \frac{{[ {α}_{y} ]}_{w}}{{δ}_{{y}_{w}} Δ y} + \frac{{[ {α}_{z} ]}_{n}}{{δ}_{{z}_{n}} Δ z} + \frac{{[ {α}_{z} ]}_{s}}{{δ}_{{z}_{s}} Δ z}$$

Therefore, the foregoing formula may be abbreviated as:

$$\frac{1}{Δ x Δ y Δ z} \int \int {\int }_{{D}_{p}} \frac{d}{dx} ( {α}_{x} \frac{d}{dx} ) + \frac{d}{dy} ( {α}_{y} \frac{d}{dy} ) + \frac{d}{dz} ( {α}_{z} \frac{d}{dz} ) dxdydz = {β}_{t} {ϕ}_{T} + {β}_{b} {ϕ}_{B} + {β}_{e} {ϕ}_{E} + {β}_{w} {ϕ}_{W} + {β}_{n} {ϕ}_{N} + {β}_{s} {ϕ}_{S} - {β}_{p} {ϕ}_{P}$$

For the Poisson's equation:

αₓ=−εₓ,α_{y}=−ε_{y},α_{z}=−ε_{z}

For a plurality of first control volumes (CV) that are gridded, the plurality of discrete Poisson's equations may be obtained, and the plurality of equations are converted into a first analytical equation set expressed in a numerical matrix format as follows:

$$[ {M}_{1} ] \overline{ϕ} = {\vec{R}}_{B 1} - \frac{q}{{ε}_{0}} \overline{n} ( \overline{ϕ} )$$

An analytical function ϕ(\vec{r}) is discretized into a column vector ϕ̅, and \vec{R}_{B1} is a vector fixed from a boundary condition. [M₁] is a 7-diagonal matrix of βᵢ (where i=t, b, e, w, n, s . . . ), and n̅(ϕ̅) is a nonlinear function of ϕ̅.

Similarly, for the Schrödinger equation at P, only ϕ needs to be changed to an eigenfunction ψ, and subsequent processes are not deduced one by one. Refer to the derivation process of the foregoing Poisson's equation, where

$${α}_{x} = \frac{{ℏ}^{2}}{2 {qm}_{x}^{*} ( \vec{r} )} , {α}_{y} = \frac{{ℏ}^{2}}{2 {qm}_{y}^{*} ( \vec{r} )} , {α}_{z} = \frac{{ℏ}^{2}}{2 {qm}_{z}^{*} ( \vec{r} )}$$

For a plurality of first CVs that are gridded, the plurality of discrete Schrödinger equations may be obtained, and the plurality of discrete Schrödinger equations are converted into a second analytical equation set expressed in a numerical matrix format as follows:

[M₂]ψ̅=\vec{R}_{B2}

An eigenfunction ψᵢ(\vec{r}) is discretized to a column vector ψ̅, and \vec{R}_{B2} is a vector fixed from a boundary condition. [M₂] is a 7-diagonal matrix of βᵢ (where i=p, t, b, e, w, n, s).

It should be noted that the boundary condition \vec{R}_{B1} and the boundary condition \vec{R}_{B2} may be the same or different, which is not limited herein.

It may be learned that [M₁] only includes a Laplace operator term in the Poisson's equation, and [M₂] not only includes a Laplace operator term in the Schrödinger equation, but also includes a potential energy term V_{eff} and an eigenvalue term eᵢ. It may be further learned that a Poisson's equation with the boundary condition \vec{R}_{B1} added is a nonlinear equation set, and a Schrödinger equation with the boundary condition \vec{R}_{B2} added is a linear equation set. The nonlinear equation set may be solved by using a Newton iteration method; and the linear equation set may be solved by using Chebyshev-Arnoldi iteration method.

The initial carrier density is preset.

Further, a specific implementation of iteratively solving the second analytical equation set based on the initial carrier density and the first analytical equation set to obtain the carrier density in the semiconductor device is as follows: solving the first analytical equation set based on the initial carrier density to obtain a first electrostatic potential; determining an estimated carrier density based on the first electrostatic potential; solving the second analytical equation set based on the estimated carrier density to obtain a first eigenfunction; determining a target carrier density based on the first eigenfunction; and if a difference between the target carrier density and the initial carrier density is greater than a preset error, using the target carrier density as a new initial carrier density, and then solving the first analytical equation set based on the new initial carrier density to obtain a first electrostatic potential; if the difference between the target carrier density and the initial carrier density is less than or equal to the preset error, using the target carrier density as the carrier density in the semiconductor device.

It should be noted that, the initial carrier density is preset; the estimated carrier density is an estimated value, and the target carrier density may be obtained more quickly by means of iterative solution; and the preset error is also set in advance.

Further, after the determining the carrier density in the semiconductor device based on the initial condition and/or the boundary condition, the Poisson's equation, and the Schrödinger equation, the method may further include.

Determining, based on the obtained carrier density, a target region with a carrier density in the geometric model being greater than or equal to a preset threshold; gridding the target region based on a finite volume method, to obtain a plurality of second control volumes, where the second control volume is smaller than the first control volume; and determining a new carrier density based on the plurality of second control volumes, and using the new carrier density as the carrier density in the semiconductor device.

It should be noted that, the new carrier density in this embodiment may be determined, for example, by using the Poisson's equation and the Schrödinger equation corresponding to the model for a closed quantum system, or by using the Poisson's equation corresponding to the model for a semi-classical system, or by using the Poisson's equation and the Schrödinger equation corresponding to the model for an open quantum system. For different physical simulation models, forms of the Schrödinger equation are different. For example, a form of the Schrödinger equation corresponding to an open physical model is different from a form of the Schrödinger equation corresponding to a closed physical model.

In the carrier transport simulation method, a Poisson's equation and a Schrödinger equation corresponding to a model for a closed quantum system are combined with an initial condition and/or a boundary condition for carrier transport in a semiconductor device, to determine a carrier density in the semiconductor device, so as to implement a simulation of carrier transport in the semiconductor device, and further implement research on carrier transport in the semiconductor device.

Specifically, if the physical simulation model is the model for an open quantum system, the determining the carrier density in the semiconductor device based on the initial condition and/or the boundary condition, and the mathematical physical equation (namely, the Poisson's equation and a Green's function equation corresponding to the Schrödinger equation) includes: determining a third analytical equation set expressed in a numerical matrix format based on the initial condition and the boundary condition for each of the first control volumes and the Poisson's equation; determining the Green's function equation corresponding to each of the first control volumes to obtain a fourth analytical equation set expressed in a numerical matrix format; determining an initial electrostatic potential; and iteratively solving the fourth analytical equation set based on the initial electrostatic potential and the third analytical equation set to obtain the carrier density in the semiconductor device.

For example, after gridding, a discrete Laplace operator that includes a parameter (αₓ, α_{y}, α_{z}) is as follows:

$$\frac{d}{dx} ( {α}_{x} \frac{d}{dx} ) + \frac{d}{dy} ( {α}_{y} \frac{d}{dy} ) + \frac{d}{dz} ( {α}_{z} \frac{d}{dz} )$$

For P in FIG. 3, a basic property of a definite integral is as follows:

$$\int \int {\int }_{{D}_{p}} \frac{d}{dx} ( {α}_{x} \frac{d}{dx} ) + \frac{d}{dy} ( {α}_{y} \frac{d}{dy} ) + \frac{d}{dz} ( {α}_{z} \frac{d}{dz} ) dxdydz = \int \int {\int }_{{D}_{p}} \frac{d}{dx} ( {α}_{x} \frac{d}{dx} ) dxdydz + \int \int {\int }_{{D}_{p}} \frac{d}{dy} ( {α}_{y} \frac{d}{dy} ) dxdydz + \int \int {\int }_{{D}_{p}} \frac{d}{dz} ( {α}_{z} \frac{d}{dz} ) dxdydz = \int {\int }_{w , e ] \times [ s , n ]} {[ {α}_{x} \frac{d ϕ}{dx} ]}_{t} - {[ {α}_{x} \frac{d ϕ}{dx} ]}_{b} dydz + \\ \int {\int }_{[ b , t ] \times [ s , n ]} {[ {α}_{y} \frac{d ϕ}{dy} ]}_{e} - {[ {α}_{y} \frac{d ϕ}{dy} ]}_{w} dxdz + \int {\int }_{[ b , t ] \times [ w , e ]} {[ {α}_{z} \frac{d ϕ}{dz} ]}_{n} - {[ {α}_{z} \frac{d ϕ}{dz} ]}_{s} dxdy$$

The foregoing formula is converted by integral average into:

$$( {[ {α}_{x} \frac{d ϕ}{dx} ]}_{t} - {[ {α}_{x} \frac{d ϕ}{dx} ]}_{b} ) Δ y Δ z + ( {[ {α}_{y} \frac{d ϕ}{dy} ]}_{t} - {[ {α}_{y} \frac{d ϕ}{dy} ]}_{b} ) Δ x Δ z + ( {[ {α}_{z} \frac{d ϕ}{dz} ]}_{t} - {[ {α}_{z} \frac{d ϕ}{dz} ]}_{b} ) Δ x Δ y$$

Central difference approximation is computed by first-order as follows:

$$( {[ {α}_{x} ]}_{t} [ \frac{{ϕ}_{T} - {ϕ}_{P}}{{δ}_{{x}_{t}}} ] - {[ {α}_{x} ]}_{b} [ \frac{{ϕ}_{P} - {ϕ}_{B}}{{δ}_{{x}_{b}}} ] ) Δ y Δ z + ( {[ {α}_{y} ]}_{e} [ \frac{{ϕ}_{E} - {ϕ}_{P}}{{δ}_{{y}_{e}}} ] - {[ {α}_{y} ]}_{w} [ \frac{{ϕ}_{P} - {ϕ}_{W}}{{δ}_{{y}_{w}}} ] ) Δ x Δ z + ( {[ {α}_{z} ]}_{n} [ \frac{{ϕ}_{N} - {ϕ}_{P}}{{δ}_{{z}_{n}}} ] - {[ {α}_{z} ]}_{s} [ \frac{{ϕ}_{P} - {ϕ}_{W}}{{δ}_{{z}_{s}}} ] ) Δ x Δ y$$

Thus, a formula may be obtained as follows:

$$\frac{1}{Δ x Δ y Δ z} \int \int {\int }_{{D}_{p}} \frac{d}{dx} ( {α}_{x} \frac{d ϕ}{dx} ) + \frac{d}{dy} ( {α}_{y} \frac{d ϕ}{dy} ) + \frac{d}{dz} ( {α}_{z} \frac{d ϕ}{dz} ) dxdydz \approx \frac{1}{Δ x Δ y Δ z} \{ ( {[ {α}_{x} ]}_{t} [ \frac{{ϕ}_{T} - {ϕ}_{P}}{{δ}_{{x}_{t}}} ] - {[ {α}_{x} ]}_{b} [ \frac{{ϕ}_{P} - {ϕ}_{B}}{{δ}_{{x}_{b}}} ] ) Δ y Δ z + ( {[ {α}_{y} ]}_{e} [ \frac{{ϕ}_{E} - {ϕ}_{P}}{{δ}_{{y}_{e}}} ] - {[ {α}_{y} ]}_{w} [ \frac{{ϕ}_{P} - {ϕ}_{W}}{{δ}_{{y}_{w}}} ] ) Δ x Δ z + ( {[ {α}_{z} ]}_{n} [ \frac{{ϕ}_{N} - {ϕ}_{P}}{{δ}_{{z}_{n}}} ] - {[ {α}_{z} ]}_{s} [ \frac{{ϕ}_{P} - {ϕ}_{W}}{{δ}_{{z}_{s}}} ] ) Δ x Δ y \} = ( \frac{{[ {α}_{x} ]}_{t}}{{δ}_{{x}_{t}} Δ x} ) {ϕ}_{T} + ( \frac{{[ {α}_{x} ]}_{b}}{{δ}_{{x}_{b}} Δ x} ) {ϕ}_{B} + ( \frac{{[ {α}_{y} ]}_{e}}{{δ}_{{y}_{e}} Δ y} ) {ϕ}_{E} + ( \frac{{[ {α}_{y} ]}_{w}}{{δ}_{{y}_{w}} Δ y} ) {ϕ}_{W} + ( \frac{{[ {α}_{z} ]}_{n}}{{δ}_{{z}_{n}} Δ z} ) {ϕ}_{N} + ( \frac{{[ {α}_{z} ]}_{s}}{{δ}_{{z}_{s}} Δ z} ) {ϕ}_{S} - ( \frac{{[ {α}_{x} ]}_{t}}{{δ}_{{x}_{t}} Δ x} + \frac{{[ {α}_{x} ]}_{b}}{{δ}_{{x}_{b}} Δ x} + \frac{{[ {α}_{y} ]}_{e}}{{δ}_{{y}_{e}} Δ y} + \frac{{[ {α}_{y} ]}_{w}}{{δ}_{{y}_{w}} Δ y} + \frac{{[ {α}_{z} ]}_{n}}{{δ}_{{z}_{n}} Δ z} + \frac{{[ {α}_{z} ]}_{s}}{{δ}_{{z}_{s}} Δ z} ) {ϕ}_{P}$$

where [αₓ]_{b,t}, [α_{y}]_{w,e}, [α_{z}]_{s,n} may be obtained through computing by using flux conservation.

Definition is as follows:

$${β}_{b , t} ≡ \frac{{[ {α}_{x} ]}_{b , t}}{{δ}_{{x}_{b , t}} Δ x} , {β}_{w , e} ≡ \frac{{[ {α}_{y} ]}_{w , e}}{{δ}_{{y}_{w , e}} Δ y} , {β}_{s , n} ≡ \frac{{[ {α}_{z} ]}_{s , n}}{{δ}_{{z}_{s , n}} Δ z} , \\ {β}_{p} ≡ \frac{{[ {α}_{x} ]}_{t}}{{δ}_{{x}_{t}} Δ x} + \frac{{[ {α}_{x} ]}_{b}}{{δ}_{{x}_{b}} Δ x} + \frac{{[ {α}_{y} ]}_{e}}{{δ}_{{y}_{e}} Δ y} + \frac{{[ {α}_{y} ]}_{w}}{{δ}_{{y}_{w}} Δ y} + \frac{{[ {α}_{z} ]}_{n}}{{δ}_{{z}_{n}} Δ z} + \frac{{[ {α}_{z} ]}_{s}}{{δ}_{{z}_{s}} Δ z}$$

Therefore, the foregoing formula may be abbreviated as:

$$\frac{1}{Δ x Δ y Δ z} \int \int {\int }_{{D}_{p}} \frac{d}{dx} ( {α}_{x} \frac{d ϕ}{dx} ) + \frac{d}{dy} ( {α}_{y} \frac{d ϕ}{dy} ) + \frac{d}{dz} ( {α}_{z} \frac{d ϕ}{dz} ) dxdydz = {β}_{t} {ϕ}_{T} + {β}_{b} {ϕ}_{B} + {β}_{e} {ϕ}_{E} + {β}_{w} {ϕ}_{W} + {β}_{n} {ϕ}_{N} + {β}_{s} {ϕ}_{S} - {β}_{p} {ϕ}_{P}$$

For the Poisson's equation:

αₓ=−εₓ,α_{y}=−ε_{y},α_{z}=−ε_{z}

For a plurality of first CVs that are gridded, the plurality of discrete Poisson's equations may be obtained, and the plurality of equations are converted into a third analytical equation set expressed in a numerical matrix format as follows:

$$[ M ] \overline{ϕ} = {\vec{R}}_{B 0} - \frac{q}{{ε}_{0}} \overline{n} ( \overline{ϕ} )$$

An analytical function ϕ(\vec{r}) is discretized into a column vector ϕ̅, and \vec{R}_{B1} is a vector fixed from a boundary condition. [M] is a 7-diagonal matrix of βᵢ (where i=p, t, b, e, w, n, s), and n̅(ϕ̅) is a nonlinear function of ϕ̅.

Similarly, for the Green's function equation at P, only ϕ needs to be changed to a Green's function G, and subsequent processes are not deduced one by one. Refer to the derivation process of the foregoing Poisson's equation, where

$${α}_{x} = \frac{{ℏ}^{2}}{2 {qm}_{x}^{*} ( \vec{r} )} , {α}_{y} = \frac{{ℏ}^{2}}{2 {qm}_{y}^{*} ( \vec{r} )} , {α}_{z} = \frac{{ℏ}^{2}}{2 {qm}_{z}^{*} ( \vec{r} )}$$

For a plurality of first CVs that are gridded, the plurality of discrete Green's function equations may be obtained, and the plurality of discrete Green's function equations are converted into a fourth analytical equation set expressed in a numerical matrix format as follows:

[A(E,\vec{ϕ})−Σ_{We}(E,\vec{ϕ}_{Left-Bo})−Σ_{Ea}(E,\vec{ϕ}_{Right-Bo})]([G(E)][ΔV])=[I]

Where A(E, \vec{ϕ}) is a numerical matrix of Hamiltonian in a finite component domain, and Σ_{We,Ea} is a self-energy matrix of west and east surfaces (of a terminal). Since an infinite system is simplified as a finite system herein, the two matrices are additional external matrices. Both boarding functions are obtained through computing by using the following formula:

Γ_{We,Ea}(E)=i[Σ_{We,Ea}(E)−Σ⁺_{We,Ea}(E)]

A size of the Broadening function is the same as that of A(E, \vec{ϕ}). However, only one block of these matrices has an element that is not zero.

Where g_{ww,ee} is referred to as surface Green's functions, which may be computed by using different methods, including an analysis method. Herein a Sancho-Rubio numerical method is considered [Refer to M. P. L. Sancho, J. M. L. Rubio, L. Rubio, J. Phys. F Met. Phys. 15 (4), 851-858 (1985)]. I_{Cw} and I_{wC} originate from interaction Hamiltonian between a transport channel and a surface terminal.

$${Σ}_{We} = [ \begin{matrix}{I}_{Cw} {g}_{ww} {I}_{wC} & 0 & 0 \\ 0 & 0 & ⋱ \\ 0 & ⋱ & ⋱\end{matrix} ] , {Σ}_{Eq} = [ \begin{matrix}⋱ & ⋱ & 0 \\ ⋱ & 0 & 0 \\ 0 & 0 & {I}_{Ce} {g}_{ee} {I}_{eC}\end{matrix} ]$$

It may be learned that [M] only includes a Laplace operator term in the Poisson's equation, and A(E, \vec{ϕ}) not only includes a Laplace operator term, but also includes an energy term (E+iη) and a potential energy term V_{eff}(\vec{r}). In the model for open quantum system, the “adiabatic” method may be used [Armagnat P, Lacerda A, Rossignol B, et al. The self-consistent quantum-electrostatic problem in strongly non-linear regime[J]. arXiv preprint arXiv:1905.01271, 2019]. A Schrödinger equation is converted into a Green's function by using a non-equilibrium Green's function method, and a finite volume method is used to discretize the Green's function to obtain a linear system. Then a recursive Green's function is used to output G(E) part with a huge parameter computation as needed, thereby further computing an electron density in the open quantum model.

Specifically, the iteratively solving the fourth analytical equation set based on the initial electrostatic potential and the third analytical equation set to obtain the carrier density in the semiconductor device includes: solving the fourth analytical equation set based on the initial electrostatic potential to obtain a second eigenfunction; determining a first initial carrier density based on the second eigenfunction; solving the third analytical equation set based on the first initial carrier density to obtain a target electrostatic potential; solving the fourth analytical equation set based on the target electrostatic potential to obtain a third eigenfunction; determining a second target carrier density based on the third eigenfunction; and if a difference between the second target carrier density and the first initial carrier density is greater than a second preset error, using the target electrostatic potential as a new initial electrostatic potential, and then solving the fourth analytical equation set based on the new initial electrostatic potential second to obtain the second eigenfunction; if the difference between the second target carrier density and the first initial carrier density is less than or equal to the second preset error, using the second target carrier density as the carrier density in the semiconductor device.

It should be noted that the initial electrostatic potential is preset; and the second preset error is also preset.

In the carrier transport simulation method, a Poisson's equation and a Green's function equation corresponding to a model for an open quantum system are combined with an initial condition and/or a boundary condition for carrier transport in a semiconductor device, to determine a carrier density in the semiconductor device, so to implement a simulation of carrier transport in the semiconductor device, and further implement research on carrier transport in the semiconductor device.

Further, after the determining the carrier density in the semiconductor device, the method further includes: determining, based on the carrier density in the semiconductor device, a target region with a carrier density in the geometric model being greater than or equal to a preset threshold; gridding the target region based on a finite volume method, to obtain a plurality of second control volumes, where the second control volume is smaller than the first control volume; and determining a new carrier density in the semiconductor device based on the plurality of second control volumes.

It should be noted that the preset threshold is preset. A method for determining the second electrostatic potential may be the same as a solution corresponding to the first control volume, or may be determined in another manner. For example, a solution method corresponding to the first control volume is a Poisson's equation, and a solution method corresponding to the second control volume is a Poisson's equation or simultaneous Poisson's equation and Schrödinger equation or simultaneous Poisson's equation and Green's function equation, which are not limited herein.

In the carrier transport simulation method, a Poisson's equation and a Green's function equation corresponding to a model for an open quantum system are combined with an initial condition and/or a boundary condition for carrier transport in a semiconductor device, to determine a carrier density in the semiconductor device, so to implement a simulation of carrier transport in the semiconductor device, and further implement research on carrier transport in the semiconductor device.

Referring to FIG. 4, FIG. 4 is a schematic structural diagram of a carrier transport simulation apparatus according to an embodiment. Corresponding to processes illustrated in FIG. 2, the apparatus includes: a first determining unit 401, configured to determine a physical simulation model, an initial condition, and/or a boundary condition for carrier transport in a semiconductor device; a second determining unit 402, configured to determine a mathematical physical equation correspondingly for solving the physical simulation model; and a third determining unit 403, configured to determine a carrier density in the semiconductor device based on the initial condition and/or the boundary condition, and the mathematical physical equation, to implement a simulation of carrier transport in the semiconductor device.

Specifically, the physical simulation model includes at least one of the following: a model for a semi-classical system, a model for a closed quantum system, and a model for an open quantum system. A mathematical physical equation corresponding to the model for a semi-classical system is a Poisson's equation; a mathematical physical equation corresponding to the model for a closed quantum system is the Poisson's equation and a Schrödinger equation; and a mathematical physical equation corresponding to the model for an open quantum system is the Poisson's equation and a Green's function equation corresponding to the Schrödinger equation.

Specifically, in terms of the determining an initial condition and/or a boundary condition for carrier transport in a semiconductor device, the first determining unit 401 is specifically configured to: construct a geometric model of the semiconductor device; grid the geometric model based on a finite volume method to obtain a plurality of first control volumes; and determine an initial condition and/or a boundary condition for each of the first control volumes.

Specifically, if the physical simulation model is the model for a semi-classical system, in terms of the determining the carrier density in the semiconductor device based on the initial condition and/or the boundary condition, and the mathematical physical equation, the third determining unit 403 is specifically configured to: determine an analytical equation set expressed in a numerical matrix format based on the initial condition and/or the boundary condition for each of the first control volumes and the Poisson's equation; transform the analytical equation set expressed in a numerical matrix format into an analytical equation set expressed in a form of residuals; solve the analytical equation set expressed in a form of residuals based on a Newton iteration algorithm to obtain a first electrostatic potential; and determine the carrier density in the semiconductor device based on the first electrostatic potential.

Specifically, if the physical simulation model is the model for a closed system, in terms of the determining the carrier density in the semiconductor device based on the initial condition and/or the boundary condition, and the mathematical physical equation, the third determining unit 403 is specifically configured to: determine a first analytical equation set expressed in a numerical matrix format based on the initial condition and the boundary condition for each of the first control volumes and the Poisson's equation; determine the Schrödinger equation corresponding to each of the first control volumes to obtain a second analytical equation set expressed in a numerical matrix format; determine an initial carrier density; and iteratively solve the second analytical equation set based on the initial carrier density and the first analytical equation set to obtain the carrier density in the semiconductor device.

Specifically, if the physical simulation model is the model for an open system, in terms of the determining the carrier density in the semiconductor device based on the initial condition and/or the boundary condition, and the mathematical physical equation, the third determining unit 403 is specifically configured to: determine a third analytical equation set expressed in a numerical matrix format based on the initial condition and the boundary condition for each of the first control volumes and the Poisson's equation; determine the Green's function equation corresponding to each of the first control volumes to obtain a fourth analytical equation set expressed in a numerical matrix format; determine an initial electrostatic potential; and iteratively solve the fourth analytical equation set based on the initial electrostatic potential and the third analytical equation set to obtain the carrier density in the semiconductor device.

Specifically, after the determining the carrier density in the semiconductor device, the third determining unit 403 is further configured to: determine, based on the carrier density in the semiconductor device, a target region with a carrier density in the geometric model being greater than or equal to a preset threshold; grid the target region based on a finite volume method, to obtain a plurality of second control volumes, where the second control volume is smaller than the first control volume; and determine a new carrier density in the semiconductor device based on the plurality of second control volumes.

In the carrier transport simulation method, a mathematical physical equation corresponding to different physical simulation models is combined with an initial condition and/or a boundary condition for carrier transport in a semiconductor device, to determine a carrier density in the semiconductor device, so as to implement a simulation of carrier transport in the semiconductor device, and further implement research on carrier transport in the semiconductor device.

Referring to FIG. 5, FIG. 5 is a schematic structural diagram of a carrier transport simulation apparatus according to an embodiment. Corresponding to processes of a model for a semi-classical system illustrated in FIG. 2, the apparatus includes: an input determining unit 501, configured to: determine an initial condition and/or a boundary condition for carrier transport in a semiconductor device, and determine a Poisson's equation corresponding to a model for a semi-classical system; and an output determining unit 502, configured to determine a carrier density in the semiconductor device based on the initial condition and/or the boundary condition and the Poisson's equation, to implement a simulation of carrier transport in the semiconductor device. Specifically, the Poisson's equation is as follows:

$$∇ \cdot ( - {ε}_{r} ( \vec{r} ) ∇ ) ϕ ( \vec{r} ) = \frac{- q}{{ε}_{0}} ( n ( \vec{r} ) )$$

Where ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density.

Specifically, n(\vec{r}) is as follows:

$$n ( \vec{r} ) = \frac{\sqrt{{m}_{x}^{*} ( \vec{r} ) {m}_{y}^{*} ( \vec{r} ) {m}_{z}^{*} ( \vec{r} )}}{{π}^{3 / 2} {ℏ}^{3}} {( {K}_{B} T )}^{3 / 2} {F}_{1 / 2} ( \frac{μ ( \vec{r} ) - {E}_{c} ( \vec{r} )}{{K}_{B} T / q} )$$

Where m*ₓ(\vec{r}), m*_{y}(\vec{r}), and m*_{z}(\vec{r}) are spatial-related directional effective masses, ℏ is a reduced Planck constant, K_{B} is a Boltzmann constant, T is a temperature in a unit of Kelvin, F_{1/2} is a half-order Fermi-Dirac integral, μ(\vec{r}) is an electrochemical potential, E_{C}(\vec{r}) is an energy at a conduction band edge, E_{c}(\vec{r})=−eϕ(\vec{r})χ₀(\vec{r}), e is an elementary charge, and χ₀(\vec{r}) is a carrier affinity.

Specifically, in terms of the determining an initial condition and/or a boundary condition for carrier transport in a semiconductor device, the input determining unit 501 is specifically configured to: construct a geometric model of the semiconductor device; grid the geometric model based on a finite volume method to obtain a plurality of first control volumes; and determine an initial condition and/or a boundary condition for each of the first control volumes.

Specifically, in terms of the determining the carrier density in the semiconductor device based on the initial condition and/or the boundary condition and the Poisson's equation, the output determining unit 502 is specifically configured to: determine an analytical equation set expressed in a numerical matrix format based on the initial condition and/or the boundary condition for each of the first control volumes and the Poisson's equation; transform the analytical equation set expressed in a numerical matrix format into an analytical equation set expressed in a form of residuals; solve the analytical equation set expressed in a form of residuals based on a Newton iteration algorithm to obtain a first electrostatic potential; and determine the carrier density in the semiconductor device based on the first electrostatic potential.

Specifically, in terms of the determining the carrier density in the semiconductor device based on the first electrostatic potential, the output determining unit 502 is specifically configured to substitute the first electrostatic potential as the electrostatic potential to be determined into n(\vec{r}) to obtain the carrier density in the semiconductor device.

Specifically, in terms of the determining the carrier density in the semiconductor device based on the first electrostatic potential, the output determining unit 502 is specifically configured to: determine, based on the first electrostatic potential, a target region with an electrostatic potential density in the geometric model being greater than or equal to a preset threshold; grid the target region based on a finite volume method, to obtain a plurality of second control volumes, where the second control volume is smaller than the first control volume; and determine a second electrostatic potential based on the plurality of second control volumes, where spatial distribution accuracy of the second electrostatic potential is higher than spatial distribution accuracy of the first electrostatic potential; and substitute the second electrostatic potential as the electrostatic potential to be determined into n(\vec{r}) to obtain the carrier density in the semiconductor device.

The carrier transport simulation apparatus shown in FIG. 5 may alternatively correspond to processes of a model for a closed system illustrated in FIG. 2, and the apparatus includes: an input determining unit 501, configured to: determine an initial condition and/or a boundary condition for carrier transport in a semiconductor device, and determine a Poisson's equation and a Schrödinger equation that are corresponding to a model for a closed quantum system; and an output determining unit 502, configured to determine a carrier density in the semiconductor device based on the initial condition and/or the boundary condition, the Poisson's equation, and the Schrödinger equation to implement a simulation of carrier transport in the semiconductor device.

Specifically, the Poisson's equation is as follows:

$$∇ \cdot ( - {ε}_{r} ( \vec{r} ) ∇ ) ϕ ( \vec{r} ) = \frac{- q}{{ε}_{0}} ( n ( \vec{r} ) )$$

Where ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density.

Specifically, the Schrödinger equation is as follows:

$$[ - ∇ \cdot \frac{{ℏ}^{2}}{2 {qm}_{x , y , z}^{*} ( \vec{r} )} ∇ + {V}_{eff} ( \vec{r} ) ] {ψ}_{i} ( \vec{r} ) = {e}_{i} {ψ}_{i} ( \vec{r} )$$

Where

$$∇ \cdot \frac{{ℏ}^{2}}{2 {qm}_{x , y , z}^{*} ( \vec{r} )} ∇$$

is a Laplace operator including

$$\frac{{ℏ}^{2}}{2 {qm}_{x , y , z}^{*} ( \vec{r} )} ,$$

ℏ is a reduced Planck constant, m*_{x,y,z}(\vec{r}) is a spatial-related directional effective mass, eᵢ and ψᵢ(\vec{r}) are an eigenvalue and an eigenfunction of a closed quantum system, respectively; V_{eff}(\vec{r}) is a valid potential energy function, V_{eff}(\vec{r})=−ϕ(\vec{r})+χ₀(\vec{r})+V_{xc}(n(\vec{r})), χ₀(\vec{r}) is a carrier affinity, and V_{xc}(n(\vec{r})) is an exchange-correlation function.

Specifically, n(\vec{r}) is as follows:

$$n ( \vec{r} ) = {\sum i}_{} {f}_{F} ( {e}_{i} ) {ψ}_{i} ( \vec{r} ) {ψ}_{i}^{+} ( \vec{r} ) = {\sum }_{i} \frac{1}{1 + exp ( ( {e}_{i} - μ ( \vec{r} ) ) / {V}_{T} )} {ψ}_{i} ( \vec{r} ) {ψ}_{i}^{+} ( \vec{r} )$$

Where ƒ_{F}(eᵢ) is a Fermi function, V_{T} is a carrier thermal voltage, V_{T}=K_{B}T/q, μ(\vec{r}) is an electrochemical potential, K_{B} is a Boltzmann constant, and T is a temperature in a unit of Kelvin.

Specifically, in terms of the determining an initial condition and/or a boundary condition for carrier transport in a semiconductor device, the input determining unit 501 is specifically configured to: construct a geometric model of the semiconductor device; grid the geometric model based on a finite volume method to obtain a plurality of first control volumes; and determine an initial condition and/or a boundary condition for each of the first control volumes.

Specifically, in terms of the determining the carrier density in the semiconductor device based on the initial condition and/or the boundary condition, the Poisson's equation, and the Schrödinger equation, the output determining unit 502 is specifically configured to: determine a first analytical equation set expressed in a numerical matrix format based on the initial condition and the boundary condition for each of the first control volumes and the Poisson's equation; determine the Schrödinger equation corresponding to each of the first control volumes to obtain a second analytical equation set expressed in a numerical matrix format; determine an initial carrier density; and iteratively solve the second analytical equation set based on the initial carrier density and the first analytical equation set to obtain the carrier density in the semiconductor device.

Specifically, the iteratively solving the second analytical equation set based on the initial carrier density and the first analytical equation set to obtain the carrier density in the semiconductor device, the output determining unit 502 is specifically configured to: solve the first analytical equation set based on the initial carrier density to obtain a first electrostatic potential; determine an estimated carrier density based on the first electrostatic potential; solve the second analytical equation set based on the estimated carrier density to obtain a first eigenfunction; determine a target carrier density based on the first eigenfunction; and if a difference between the target carrier density and the initial carrier density is greater than a preset error, use the target carrier density as a new initial carrier density, and then solve the first analytical equation set based on the new initial carrier density to obtain a first electrostatic potential; if the difference between the target carrier density and the initial carrier density is less than or equal to the preset error, use the target carrier density as the carrier density in the semiconductor device.

The carrier transport simulation apparatus shown in FIG. 5 may alternatively correspond to processes of a model for an open system illustrated in FIG. 2, and the apparatus includes: an input determining unit 501, configured to: determine an initial condition and/or a boundary condition for carrier transport in a semiconductor device, and determine a Poisson's equation corresponding to a model for an open quantum system and a Green's function equation corresponding to a Schrödinger equation; and an output determining unit 502, configured to determine the carrier density in the semiconductor device based on the initial condition and/or the boundary condition, the Poisson's equation, and the Green's function equation corresponding to the Schrödinger equation, to implement a simulation of carrier transport in the semiconductor device.

Specifically, the Poisson's equation is as follows:

$$∇ \cdot ( - {ε}_{r} ( \vec{r} ) ∇ ) ϕ ( \vec{r} ) = \frac{- q}{{ε}_{0}} ( n ( \vec{r} ) )$$

Where ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density.

Specifically, the Green's function equation corresponding to the Schrödinger equation is as follows:

$$( ( E + i η ) - ( - ∇ \cdot \frac{{ℏ}^{2}}{2 {qm}_{x , y , z}^{*} ( \vec{r} )} ∇ + {V}_{eff} ( \vec{r} ) ) ) G ( \vec{r} , \vec{{r}^{′}} ; E ) = δ ( \vec{r} - \vec{{r}^{′}} )$$

Where (E+iη) is energy,

$$∇ \cdot \frac{{ℏ}^{2}}{2 {qm}_{x , y , z}^{*} ( \vec{r} )} ∇$$

is a Laplace operator including

$$\frac{{ℏ}^{2}}{2 {qm}_{x , y , z}^{*} ( \vec{r} )} ,$$

ℏ is a reduced Planck constant, m*_{x,y,z}(\vec{r}) is a spatial-related directional effective mass, G(\vec{r}, \vec{r′}; E) is a single-particle Green function corresponding to energy, δ(\vec{r}−\vec{r′}) is a Dirac function; V_{eff}(\vec{r}) is a valid potential energy function, V_{eff}(\vec{r})=−ϕ(\vec{r})+χ₀(\vec{r})+V_{xc}(n(\vec{r})), χ₀(\vec{r}) is a carrier affinity, and V_{xc}(n(\vec{r})) is an exchange-correlation function.

Specifically, n(\vec{r}) is as follows:

n(\vec{r})∫_{μ}_{_{Ea}}_{-Δμ}^{μ}^{_{We}}^{+Δμ}{diag[G(\vec{r},\vec{r′};E)Γ_{We}(E)G⁺(\vec{r},\vec{r′};E)]×ƒ_{We}(μ_{We},E)+diag[G(\vec{r},\vec{r′};E)Γ_{Ea}(E)G⁺(\vec{r},\vec{r′};E)]×ƒ_{Ea}(μ_{Ea,}E)}dE

Where ƒ_{We}(μ_{We}, E) and ƒ_{Ea}(μ_{Ea}, E) are Fermi functions respectively at a port We and a port Ea in the geometric model, μ_{We} and μ_{μ}_{_{Ea}} are electrochemical potentials of the port We and the port Ea, respectively, and Γ_{We}, (E) and Γ_{Ea}(E) are spread functions of the port We and the port Ea, respectively.

Specifically, in terms of the determining an initial condition and/or a boundary condition for carrier transport in a semiconductor device, the input determining unit 501 is specifically configured to: construct a geometric model of the semiconductor device; grid the geometric model based on a finite volume method to obtain a plurality of first control volumes; and determine an initial condition and/or a boundary condition for each of the first control volumes.

Specifically, in terms of the determining the carrier density in the semiconductor device based on the initial condition and/or the boundary condition, the Poisson's equation, and the Green's function equation corresponding to the Schrödinger equation, the output determining unit 502 is specifically configured to: determine a first analytical equation set expressed in a numerical matrix format based on the initial condition and the boundary condition for each of the first control volumes and the Poisson's equation; determine the Green's function equation corresponding to the Schrödinger equation that is corresponding to each of the first control volumes to obtain a second analytical equation set expressed in a numerical matrix format; determine an initial electrostatic potential; and iteratively solve the second analytical equation set based on the initial electrostatic potential and the first analytical equation set to obtain the carrier density in the semiconductor device.

Specifically, the iteratively solving the second analytical equation set based on the initial electrostatic potential and the first analytical equation set to obtain the carrier density in the semiconductor device, the output determining unit 502 is specifically configured to: solve the second analytical equation set based on the initial electrostatic potential to obtain a first eigenfunction; determine an initial carrier density based on the first eigenfunction; solve the first analytical equation set based on the initial carrier density to obtain a target electrostatic potential; solve the second analytical equation set based on the target electrostatic potential to obtain a second eigenfunction; determine a target carrier density based on the second eigenfunction; and if a difference between the target carrier density and the initial carrier density is greater than a preset error, use the target electrostatic potential as a new initial electrostatic potential, and then solve the second analytical equation set based on the initial electrostatic potential to obtain a first eigenfunction; if the difference between the target carrier density and the initial carrier density is less than or equal to the preset error, use the target carrier density as the carrier density in the semiconductor device.

Another embodiment provides a non-transitory computer-readable storage medium. The non-transitory computer-readable storage medium stores a computer program. When the computer program is run, the steps in any method embodiment are performed.

In this embodiment, the non-transitory computer-readable storage medium may be configured to store a computer program for performing the following steps: determining a physical simulation model, an initial condition, and/or a boundary condition for carrier transport in a semiconductor device; determining a mathematical physical equation correspondingly for solving the physical simulation model; and determining a carrier density in the semiconductor device based on the initial condition and/or the boundary condition, and the mathematical physical equation, to implement a simulation of carrier transport in the semiconductor device.

In another embodiment, the non-transitory computer-readable storage medium may be configured to store a computer program for performing the following steps: determining an initial condition and/or a boundary condition for carrier transport in a semiconductor device, and determining a Poisson's equation corresponding to a model for a semi-classical system; and determining a carrier density in the semiconductor device based on the initial condition and/or the boundary condition, and the Poisson's equation, to implement a simulation of carrier transport in the semiconductor device.

In another embodiment, the non-transitory computer-readable storage medium may be configured to store a computer program for performing the following steps: determining an initial condition and/or a boundary condition for carrier transport in a semiconductor device, and determining a Poisson's equation and a Schrödinger equation that are corresponding to a model for a closed quantum system; and determining the carrier density in the semiconductor device based on the initial condition and/or the boundary condition, the Poisson's equation, and the Schrödinger equation, to implement a simulation of carrier transport in the semiconductor device.

In another embodiment, the non-transitory computer-readable storage medium may be configured to store a computer program for performing the following steps: determining an initial condition and/or a boundary condition for carrier transport in a semiconductor device, and determining a Poisson's equation corresponding to a model for an open quantum system and a Green's function equation corresponding to a Schrödinger equation; and determining the carrier density in the semiconductor device based on the initial condition and/or the boundary condition, the Poisson's equation, and the Green's function equation corresponding to the Schrödinger equation, to implement the simulation of carrier transport in the semiconductor device.

In this embodiment, the foregoing non-transitory computer-readable storage medium may include but is not limited to any medium that may store a computer program, for example, a USB flash drive, a read-only memory (ROM), a random access memory (RAM),a removable hard disk, a magnetic disk, or an optical disc.

Another embodiment further provides an electronic device, including a memory and a processor, where the memory stores a computer program, and the processor is set to run the computer program to perform the steps in the foregoing method embodiments.

The carrier apparatus may further include a transmission device and an input/output device. The transmission device is connected to the processor. The input/output device is connected to the processor.

In this embodiment, the processor may be configured to perform the following steps through a computer program: determining a physical simulation model, an initial condition, and/or a boundary condition for carrier transport in a semiconductor device; determining a mathematical physical equation correspondingly for solving the physical simulation model; and determining a carrier density in the semiconductor device based on the initial condition and/or the boundary condition, and the mathematical physical equation, to implement a simulation of carrier transport in the semiconductor device.

In another embodiment, the processor may be configured to perform the following steps through a computer program: determining an initial condition and/or a boundary condition for carrier transport in a semiconductor device, and determining a Poisson's equation corresponding to a model for a semi-classical system; and determining a carrier density in the semiconductor device based on the initial condition and/or the boundary condition, and the Poisson's equation, to implement a simulation of carrier transport in the semiconductor device.

In another embodiment, the processor may be configured to perform the following steps through a computer program: determining an initial condition and/or a boundary condition for carrier transport in a semiconductor device, and determining a Poisson's equation and a Schrödinger equation that are corresponding to a model for a closed quantum system; and determining a carrier density in the semiconductor device based on the initial condition and/or the boundary condition, the Poisson's equation, and the Schrödinger equation, to implement a simulation of carrier transport in the semiconductor device.

In another embodiment, the processor may be configured to perform the following steps through a computer program: determining an initial condition and/or a boundary condition for carrier transport in a semiconductor device, and determining a Poisson's equation corresponding to a model for an open quantum system and a Green's function equation corresponding to a Schrödinger equation; and determining a carrier density in the semiconductor device based on the initial condition and/or the boundary condition, the Poisson's equation, and the Green's function equation corresponding to the Schrödinger equation, to implement the simulation of carrier transport in the semiconductor device.

The constructions, features, functions, and effects of embodiments are described in detail in the embodiments with reference to the accompanying drawings. The foregoing descriptions are merely preferred embodiments, and the embodiments are not limited by the accompanying drawings. All equivalent embodiments that are changed or modified according to the concept of the embodiments and do not depart from the spirit of the specification and the drawings should fall within the protection scope of the present disclosure.

What is claimed is:

1. A carrier transport simulation method, comprising:
determining a physical simulation model, an initial condition, and/or a boundary condition for carrier transport in a semiconductor device;
determining a mathematical physical equation correspondingly for solving the physical simulation model; and
determining a carrier density in the semiconductor device based on the initial condition and/or the boundary condition, and the mathematical physical equation, to implement a simulation of carrier transport in the semiconductor device.

2. The method according to claim 1, wherein the physical simulation model comprises at least one of the following: a model for a semi-classical system, a model for a closed quantum system, and a model for an open quantum system; a mathematical physical equation corresponding to the model for a semi-classical system is a Poisson's equation; a mathematical physical equation corresponding to the model for a closed quantum system is the Poisson's equation and a Schrödinger equation; and a mathematical physical equation corresponding to the model for an open quantum system is the Poisson's equation and a Green's function equation corresponding to the Schrödinger equation.

3. The method according to claim 2, wherein the determining an initial condition and/or a boundary condition for carrier transport in a semiconductor device comprises:
constructing a geometric model of the semiconductor device;
gridding the geometric model based on a finite volume method to obtain a plurality of first control volumes; and
determining an initial condition and/or a boundary condition for each of the first control volumes.

4. The method according to claim 3, wherein if the physical simulation model is the model for a semi-classical system, the determining a carrier density in the semiconductor device based on the initial condition and/or the boundary condition, and the mathematical physical equation comprises:
determining an analytical equation set expressed in a numerical matrix format based on the initial condition and/or the boundary condition for each of the first control volumes and the Poisson's equation;
transforming the analytical equation set expressed in a numerical matrix format into an analytical equation set expressed in a form of residuals;
solving the analytical equation set expressed in a form of residuals based on a Newton iteration algorithm to obtain a first electrostatic potential; and
determining the carrier density in the semiconductor device based on the first electrostatic potential.

5. The method according to claim 3, wherein if the physical simulation model is the model for a closed quantum system, the determining a carrier density in the semiconductor device based on the initial condition and/or the boundary condition, and the mathematical physical equation comprises:
determining a first analytical equation set expressed in a numerical matrix format based on the initial condition and the boundary condition for each of the first control volumes and the Poisson's equation;
determining the Schrödinger equation corresponding to each of the first control volumes to obtain a second analytical equation set expressed in a numerical matrix format;
determining an initial carrier density; and
iteratively solving the second analytical equation set based on the initial carrier density and the first analytical equation set to obtain the carrier density in the semiconductor device.

6. The method according to claim 3, wherein if the physical simulation model is the model for an open quantum system, the determining a carrier density in the semiconductor device based on the initial condition and/or the boundary condition, and the mathematical physical equation comprises:
determining a third analytical equation set expressed in a numerical matrix format based on the initial condition and the boundary condition for each of the first control volumes and the Poisson's equation;
determining the Green's function equation corresponding to each of the first control volumes to obtain a fourth analytical equation set expressed in a numerical matrix format;
determining an initial electrostatic potential; and
iteratively solving the fourth analytical equation set based on the initial electrostatic potential and the third analytical equation set to obtain the carrier density in the semiconductor device.

7. The method according to claim 3, wherein after the determining the carrier density in the semiconductor device, the method further comprises:
determining, based on the carrier density in the semiconductor device, a target region with a carrier density in the geometric model being greater than or equal to a preset threshold;
gridding the target region based on a finite volume method, to obtain a plurality of second control volumes, wherein the second control volume is smaller than the first control volume; and
determining a new carrier density in the semiconductor device based on the plurality of second control volumes.

8. The method according to claim 1, wherein the mathematical physical equation is used to represent a law of change of a physical quantity in space and time.

9. The method according to claim 4, wherein the Poisson's equation is as follows:
$$∇ \cdot ( - {ε}_{r} ( \vec{r} ) ∇ ) ϕ ( \vec{r} ) = \frac{- q}{{ε}_{0}} ( n ( \vec{r} ) ) ,$$
wherein ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density;
the n(\vec{r}) is as follows:
$$n ( \vec{r} ) = \frac{\sqrt{{m}_{x}^{*} ( \vec{r} ) {m}_{y}^{*} ( \vec{r} ) {m}_{z}^{*} ( \vec{r} )}}{{π}^{3 / 2} {ℏ}^{3}} {( {K}_{B} T )}^{3 / 2} {F}_{1 / 2} ( \frac{μ ( \vec{r} ) - {E}_{C} ( \vec{r} )}{{K}_{B} T / q} ) ,$$
wherein m*ₓ(\vec{r}), m*_{y}(\vec{r}), and m*_{z}(\vec{r}) are spatial-related directional effective masses, ℏ is a reduced Planck constant, K_{B} is a Boltzmann constant, T is a temperature in a unit of Kelvin, F_{1/2} is a half-order Fermi-Dirac integral, μ(\vec{r}) is an electrochemical potential, E_{C}(\vec{r}) is an energy at a conduction band edge, E_{c}(\vec{r})=−eϕ(\vec{r})χ₀(\vec{r}), e is an elementary charge, and χ₀(\vec{r}) is a carrier affinity.

10. The method according to claim 9, wherein the determining the carrier density in the semiconductor device based on the first electrostatic potential comprises:
substituting the first electrostatic potential as the electrostatic potential to be determined into n(\vec{r}) to obtain the carrier density in the semiconductor device.

11. The method according to claim 10, wherein the determining the carrier density in the semiconductor device based on the first electrostatic potential comprises:
determining, based on the first electrostatic potential, a target region with an electrostatic potential density in the geometric model being greater than or equal to a preset threshold;
gridding the target region based on a finite volume method, to obtain a plurality of second control volumes, wherein the second control volume is smaller than the first control volume;
determining a second electrostatic potential based on the plurality of second control volumes, wherein spatial distribution accuracy of the second electrostatic potential is higher than spatial distribution accuracy of the first electrostatic potential;
and substituting the second electrostatic potential as the electrostatic potential to be determined into n(\vec{r}) to obtain the carrier density in the semiconductor device.

12. The method according to claim 5, wherein the Poisson's equation is as follows:
$$∇ \cdot ( - {ε}_{r} ( \vec{r} ) ∇ ) ϕ ( \vec{r} ) = \frac{- q}{{ε}_{0}} ( n ( \vec{r} ) ) ,$$
wherein ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density.
the Schrödinger equation is as follows:
$$[ - ∇ \cdot \frac{{ℏ}^{2}}{2 {qm}_{x , y , z}^{*} ( \vec{r} )} ∇ + {V}_{eff} ( \vec{r} ) ] {ψ}_{i} ( \vec{r} ) = {e}_{i} {ψ}_{i} ( \vec{r} ) ,$$
wherein
$$∇ \cdot \frac{{ℏ}^{2}}{2 {qm}_{x , y , z}^{*} ( \vec{r} )} ∇$$
is a Laplace operator including
$$\frac{{ℏ}^{2}}{2 {qm}_{x , y , z}^{*} ( \vec{r} )} ,$$
ℏ is a reduced Planck constant, m*_{x,y,z}(\vec{r}) is a spatial-related directional effective mass, eᵢ and ψᵢ(\vec{r}) are an eigenvalue and an eigenfunction of a closed quantum system, respectively; V_{eff}(\vec{r}) is a valid potential energy function, V_{eff}(\vec{r})=−ϕ(\vec{r})+χ₀(\vec{r})+V_{xc}(n(\vec{r})), χ₀(\vec{r}) is a carrier affinity, and V_{xc}(n(\vec{r})) is an exchange-correlation function;
the n(\vec{r}) is as follows:
$$n ( \vec{r} ) = {\sum }_{i} {f}_{F} ( {e}_{i} ) {ψ}_{i} ( \vec{r} ) {ψ}_{i}^{+} ( \vec{r} ) = {\sum }_{i} \frac{1}{1 + exp ( ( {e}_{i} - μ ( \vec{r} ) ) / {V}_{T} )} {ψ}_{i} ( \vec{r} ) {ψ}_{i}^{+} ( \vec{r} ) ,$$
wherein ƒ_{F}(eᵢ) is a Fermi function, V_{T} is a carrier thermal voltage, V_{T}=K_{B}T/q, μ(\vec{r}) is an electrochemical potential, K_{B} is a Boltzmann constant, and T is a temperature in a unit of Kelvin.

13. The method according to claim 5, wherein the iteratively solving the second analytical equation set based on the initial carrier density and the first analytical equation set to obtain the carrier density in the semiconductor device comprises:
solving the first analytical equation set based on the initial carrier density to obtain a first electrostatic potential;
determining an estimated carrier density based on the first electrostatic potential;
solving the second analytical equation set based on the estimated carrier density to obtain a first eigenfunction; determining a target carrier density based on the first eigenfunction; and
when a difference between the target carrier density and the initial carrier density is greater than a preset error, using the target carrier density as a new initial carrier density, and solving the first analytical equation set based on the new initial carrier density to obtain a first electrostatic potential;
when the difference between the target carrier density and the initial carrier density is less than or equal to the preset error, using the target carrier density as the carrier density in the semiconductor device.

14. The method according to claim 6, wherein the Poisson's equation is as follows:
$$∇ \cdot ( - {ε}_{r} ( \vec{r} ) ∇ ) ϕ ( \vec{r} ) = \frac{- q}{{ε}_{0}} ( n ( \vec{r} ) ) ,$$
wherein ∇·(−εᵣ(\vec{r})∇) is a Laplace operator including εᵣ(\vec{r}), εᵣ(\vec{r}) is a relative static dielectric constant of the semiconductor device, ϕ(\vec{r}) is an electrostatic potential to be determined, ε₀ is a vacuum dielectric constant, q is a carrier charge amount, and n(\vec{r}) is a carrier density;
the Green's function equation corresponding to the Schrödinger equation is as follows:
$$( ( E + i η ) - ( - ∇ \cdot \frac{{ℏ}^{2}}{2 {qm}_{x , y , z}^{*} ( \vec{r} )} ∇ + {V}_{eff} ( \vec{r} ) ) ) G ( \vec{r} , \vec{{r}^{′}} ; E ) = δ ( \vec{r} - \vec{{r}^{′}} ) ,$$
wherein (E+iη) is energy,
$$∇ \cdot \frac{{ℏ}^{2}}{2 {qm}_{x , y , z}^{*} ( \vec{r} )} ∇$$
is a Laplace operator including
$$\frac{{ℏ}^{2}}{2 {qm}_{x , y , z}^{*} ( \vec{r} )}$$
ℏ is a reduced Planck constant, m*_{x,y,z}(\vec{r}) is a spatial-related directional effective mass, G(\vec{r}, \vec{r′}; E) is a single-particle Green function corresponding to energy, δ(\vec{r}−\vec{r′}) is a Dirac function; V_{eff}(\vec{r}) is a valid potential energy function, V_{eff}(\vec{r})=−ϕ(\vec{r})+χ₀(\vec{r})+V_{xc}(n(\vec{r})), χ₀(\vec{r}) is a carrier affinity, and V_{xc}(n(\vec{r})) is an exchange-correlation function;
n(\vec{r}) is as follows:
n(\vec{r})∫_{μ}_{_{Ea}}_{-Δμ}^{μ}^{_{We}}^{+Δμ}{diag[G(\vec{r},\vec{r′};E)Γ_{We}(E)G⁺(\vec{r},\vec{r′};E)]×ƒ_{We}(μ_{We},E)+diag[G(\vec{r},\vec{r′};E)Γ_{Ea}(E)G⁺(\vec{r},\vec{r′};E)]×ƒ_{Ea}(μ_{Ea,}E)}dE
wherein ƒ_{We}(μ_{We}, E) and ƒ_{Ea}(μ_{Ea}, E) are Fermi functions respectively at a port We and a port Ea in the geometric model, μ_{We} and μ_{μ}_{_{Ea}} are electrochemical potentials of the port We and the port Ea, respectively, and Γ_{We}, (E) and Γ_{Ea}(E) are spread functions of the port We and the port Ea, respectively.

15. The method according to claim 6, wherein the iteratively solving the fourth analytical equation set based on the initial electrostatic potential and the third analytical equation set to obtain the carrier density in the semiconductor device comprises:
solving the fourth analytical equation set based on the initial electrostatic potential to obtain a first eigenfunction;
determining an initial carrier density based on the first eigenfunction;
solving the third analytical equation set based on the initial carrier density to obtain a target electrostatic potential;
solving the fourth analytical equation set based on the target electrostatic potential to obtain a second eigenfunction;
determining a target carrier density based on the second eigenfunction; and
when a difference between the target carrier density and the initial carrier density is greater than a preset error, using the target electrostatic potential as a new initial electrostatic potential, and solving the fourth analytical equation set based on the new initial electrostatic potential to obtain a first eigenfunction;
when the difference between the target carrier density and the initial carrier density is less than or equal to the preset error, using the target carrier density as the carrier density in the semiconductor device.

16. The method according to claim 1, wherein the boundary condition refers to a law of a variable solved on a boundary of a solution region or a derivative of the variable changing with time and location.

17. The method according to claim 1, wherein the boundary condition includes a first type of boundary conditions for a given endpoint value, a second type of boundary conditions for a given gradient value, and a third type of boundary conditions for a given endpoint value and a given gradient value.

18. A carrier transport simulation apparatus, comprising:
a first determining unit, configured to determine a physical simulation model, an initial condition, and/or a boundary condition for carrier transport in a semiconductor device;
a second determining unit, configured to determine a mathematical physical equation correspondingly for solving the physical simulation model; and
a third determining unit, configured to determine a carrier density in the semiconductor device based on the initial condition and/or the boundary condition, and the mathematical physical equation, to implement a simulation of carrier transport in the semiconductor device.

19. A non-transitory computer-readable storage medium, wherein the non-transitory computer-readable storage medium stores a computer program, and when the computer program is run, the following method is performed:
determining a physical simulation model, an initial condition, and/or a boundary condition for carrier transport in a semiconductor device;
determining a mathematical physical equation correspondingly for solving the physical simulation model; and
determining a carrier density in the semiconductor device based on the initial condition and/or the boundary condition, and the mathematical physical equation, to implement a simulation of carrier transport in the semiconductor device.

20. An electronic device, comprising a memory and a processor, wherein the memory stores a computer program, and the processor is configured to run the computer program, so that the method according to claim 1 is performed.
